(19) United States
(12) Patent Application Publication
(10) Pub. No.: US 2025/0334738 A1
(43) Pub. Date: Oct. 30, 2025

(54) STRESS STRUCTURES FOR MODULATING OPTICAL DEVICES

(71) Applicant: Taiwan Semiconductor Manufacturing Company, Ltd., Hsinchu (TW)

(72) Inventors: Chun-Yen Peng, Hsinchu (TW); Hau-Yan Lu, Hsinchu City (TW); Wei-Kang Liu, Taichung City (TW); Yingkit Felix Tsui, Cupertino, CA (US)

(21) Appl. No.: 19/263,568

(22) Filed: Jul. 9, 2025

Related U.S. Application Data
(63) Continuation of application No. 18/736,916, filed on Jun. 7, 2024.
(60) Provisional application No. 63/552,307, filed on Feb. 12, 2024.

(51) Int. Cl. G02B 6/122; G02B 6/12; G02B 6/134; G02B 6/136

(52) U.S. Cl. CPC G02B 6/122; G02B 6/1347; G02B 6/136; G02B 2006/121; G02B 2006/12152

(57) ABSTRACT

A photonic integrated circuit (PIC) includes a stress structure that produces a stress field that enhances an optical device. The enhancement may enlarge an optical mode of the optical device, control an optical mode of the optical device, induce a transition between TM mode preferred and TE mode preferred so that the optical device is made operative as a mode converter, increase a coupling efficiency of the optical device, alter an absorption spectrum of the optical device, or counteract stress noise so as to prevent the stress noise from degrading the optical device. The stress structure may be composed of islands of material having a CTE mismatch or like contrast with a surrounding material. The islands may be periodically spaced along a length of the device and may be symmetrically disposed on opposite sides of the device.

### REFERENCE TO RELATED APPLICATIONS

This Application is a Continuation of U.S. application Ser. No. 18/736,916, filed on Jun. 7, 2024, which claims the benefit of U.S. Provisional Application No. 63/552,307, filed on Feb. 12, 2024. The contents of the above-referenced patent applications are hereby incorporated by reference in their entirety.

### BACKGROUND

Photonic integrated circuits (PICs) are widely used in communications and are increasingly being used for sensing and computing. PICs may operate at higher speeds than electrical integrated circuits (ICs) and may be combined with ICs to enhance functionality. A PIC includes two or more optical devices coupled to form a circuit. Examples of optical devices include waveguides, splitters, multiplexers, filters, modulators, sensors, and switches. A PIC may interface with an optical transmitter or receiver such as a laser or an optical fiber through a grating coupler, an edge coupler, or the like.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A illustrates a cross-sectional view and FIG. 1B illustrates a plan view of an optical device with a stress structure according to some embodiments. FIG. 1A is a cross-section taken along the line A-A′ of FIG. 1B.

FIGS. 2-5 illustrate cross-sectional views of optical devices with stress structures according to various embodiments.

FIG. 6 illustrates a plan view of an optical device with a stress structure according to another embodiment.

FIGS. 7-17B illustrate cross-sectional views of optical devices with stress structures according to various embodiments.

FIG. 15A illustrates a cross-sectional view and FIG. 15B illustrates a plan view of an optical device with a stress structure according to some embodiments. FIG. 15A is a cross-section taken along the line A-A′ of FIG. 15B.

FIG. 16A-20A illustrate cross-sectional views and FIGS. 16B-20B illustrate plan views of optical devices with stress structure according to various embodiments. The “A” figures are cross-section taken along the lines A-A′ in the “B” figures.

FIGS. 21A-21C illustrate cross-sectional views and FIG. 21D illustrates a plan view of a mode converter with a stress structure according to an embodiment. The “A”, “B”, and “C” figures are cross-section taken along the lines A-A′, B-B′, and C-C′ respectively of the plan view of FIG. 21D.

FIG. 22 is a plot showing relationships of TM-mode and TE-mode refractive indexes to stress for an exemplary waveguide and stress structure.

FIG. 23A-24A illustrate cross-sectional views and FIGS. 23B-24B illustrate plan views of mode converters with stress structure according to various embodiments. The “A” figures are cross-section taken along the lines A-A′ in the “B” figures.

FIGS. 25-28 illustrate cross-sectional views of mode converters with stress structures according to various embodiments.

FIG. 29A illustrates a cross-sectional view and FIG. 29B illustrates a plan view of a PiN modulator with a stress structure according to an embodiment. FIG. 29A is a cross-section taken along the line A-A′ of FIG. 29B.

FIG. 30A illustrates a cross-sectional view and FIG. 30B illustrates a plan view of a ring resonator with a stress structure according to an embodiment. FIG. 30A is a cross-section taken along the line A-A′ of FIG. 30B.

FIG. 31A illustrates a cross-sectional view and FIG. 31B illustrates a plan view showing a group of electro-absorption modulators having various stress structures in accordance with an embodiment. FIG. 31A is a cross-section taken along the line A-A′ of FIG. 31B.

FIGS. 32-51 provide a series of cross-sectional views illustrating a manufacturing process in accordance with some embodiments.

FIG. 52 provides a flow chart illustrating a manufacturing process in accordance with some embodiments.

FIG. 53 provides a flow chart illustrating a design process in accordance with an embodiment.

### DETAILED DESCRIPTION

The present disclosure provides many different embodiments, or examples, for implementing different features of this disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Optical devices can be highly sensitive to variations in refractive index. Variations in refractive index may be caused by stress. An optical propagation region of an optical device in a PIC may be stressed by nearby structures that have intrinsic stress. A structure of one material may have intrinsic stress due to a temperature of manufacture and a coefficient-of-thermal expansion (CTE) mismatch with respect to the CTEs of surrounding materials, or due to some other effect. If the stress field is unplanned, it will tend to degrade the performance of the optical device.

Some aspects of the present disclosure relate to a photonic integrated circuit (PIC) device comprising a stress structure that produces a stress field that enhances an optical device. In some embodiments, the enhancement enlarges an optical mode of (a range of wavelengths transmitted by) the optical device. In some embodiments, the enhancement is to control a mode of the optical device make a region of the optical device TM mode preferred or TE mode preferred. In some embodiment, the enhancement induces a transition between TM mode preferred and TE mode preferred so that the optical device is made operative as a mode converter. In some embodiment, the enhancement is to increase a coupling efficiency of the optical device. In some embodiment, the enhancement is to alter an absorption spectrum of the optical device. In some embodiments, the enhancement is to counteract stress noise (unplanned stresses) so as to prevent the stress noise from degrading the optical device.

A stress structure may be a consequence of a CTE mismatch with an adjacent material. The CTE mismatch is generally at least about 1×10⁻⁶/K. In some embodiments, the CTE mismatch is generally at least about 5×10⁻⁶/K. A difference between the temperature of manufacture and the temperature of operation is generally at least about 200 K. In some embodiments, the difference is at least about 500 K. In some embodiments, the difference is at least about 800 K. A stress structure may also be produced by ion implantation or some other process that produces a localized change in density or crystallinity of a material. In general, the stress structure is not part of any electrical or PIC except in respect to its providing stress that enhances the functionality of an optical device. In some embodiment, the stress structure shares a composition with the adjacent material, the CTE mismatch being the result of a difference in doping, density, crystal structure, or the like. Providing the stress structure using the same composition as the surrounding material may improve optical performance. In some embodiment, the stress structure has a distinct composition from the adjacent material. Using a different material for the stress structure facilitates controlling stiffness and CTE so as to produce a predetermined amount of stress.

In some embodiments, the stress structure includes a plurality of islands of material having a CTE mismatch with an adjacent material or having some other contrast with the adjacent material that results in intrinsic stress. In some embodiment, the adjacent material surrounds each of the islands in a horizontal plane. In some embodiments, the islands are periodically spaced. The periodic spacing may cause a low amplitude oscillation in the stress field along a transmission path of the optical device. Providing the stress structures as groups of islands as opposed to monolithic structures helps prevent overconcentration of stresses that may cause cracking or warping of wafers.

In some embodiments, the islands are in a symmetric arrangement around the optical device. In some embodiments, the optical device defines an optical transmission path, and the islands form a row that parallels the optical transmission path. In some embodiments, the islands form two or more rows on opposite sides of the optical device. In some embodiments, the islands form four or more rows in a symmetric arrangement around the optical device. In some embodiments, the stress structures have rounded lower surfaces. In some embodiments, the stress structures have rounded upper surfaces. In some embodiments, the stress structures have rounded side surfaces. Rounded structures provide more uniform stress fields.

The PIC device may comprise a buried oxide (BOX) substrate. A BOX substrate includes a handle substrate, a buried oxide layer, and a top layer. The photonic integrated in circuit is provided in part by the top layer. Cladding may be disposed over the top layer. A metal interconnect structure with electrical connection to the PIC may be disposed over the cladding. In some embodiments, the stress structures are embedded in the top layer.

In some embodiments, the stress structure is embedded in the cladding. In some embodiments, the stress structure embedded in the cladding abuts the optical device. In some embodiments, the stress structure embedded in the cladding is at a height of the optical device. In some embodiments, the stress structure embedded in the cladding is lateral to the optical device and above the optical device. In some embodiments, the stress structure embedded in the cladding is directly above the optical device.

In some embodiments, the stress structure is embedded in a metallization layer of the metal interconnect structure. In some embodiments, the stress structure is provided by dummy metal in the metallization layer. In some embodiments, the stress structure disposed in the metallization layer shares a composition with an interlevel dielectric of the metallization layer but has a CTE mismatch or other stress-inducing property difference with the interlevel dielectric. In some embodiments, the stress structure embedded in the metallization layer has a composition distinct from the metal and the interlevel dielectric of the metallization layer. In some embodiments, the stress structure embedded in the metallization layer extends downward into the cladding.

An optical device may be any device that transmits, receives, propagates, generates, modifies, or detects optical signals, any device that transform optical signals to electrical signals, or any device that transforms electrical signals to optical signal. Examples of optical devices that transmit, receive, propagate, generate, modify, or detect optical signals include waveguides, splitters, multiplexers, filters, modulators (e.g., a phase shifter, a PiN modulator, or an electro-absorption modulator), sensors, switches (e.g., a Mach-Zehnder interferometer), amplifiers, edge couplers, grating couplers, ring resonators, and the like. Examples of optical devices that transforms electrical signals to optical signals include laser diodes, light-emitting diodes, and the like. Examples of optical devices that transform optical signals to electrical signals include photodetectors and the like. In some embodiments, there are multiple instances of the optical device in the PIC, and each instance is associated with an equivalent and corresponding stress structure. In some embodiments, there are multiple instances of the optical device in the PIC, and each instance is associated with one in a range of distinct stress structures. The range of corresponding stress structures may include a systematic variation that provides the set of optical devices with a range of predetermined device properties.

In some embodiments, the optical device is a photodetector. An absorption spectrum for the photodetector may be modulated by the stress structure. In some embodiments, the PIC includes a plurality of photodetectors having a range of distinct absorptions spectrums, wherein the differences in the absorption spectrums are modulated by stress structures associated with the photodetectors.

In some embodiments, the optical device is an electro-absorption modulator. An absorption spectrum for the electro-absorption modulator may be modulated by the stress structure. In some embodiments, the PIC includes a plurality of electro-absorption modulators having a range of distinct absorptions spectrums, wherein the differences in the absorption spectrums are determined by differences in the stress fields modulated by stress structures associated with the electro-absorption modulators.

In some embodiments, the optical device is a waveguide. In some embodiments, the waveguide is TM mode preferred or TE mode preferred as a result of a stress field modulated by the stress structure. In some embodiments, the optical device is a PiN modulator, and the stress structure modulates whether PiN modulator is TM mode preferred or TE mode preferred at a particular operating voltage.

In some embodiments, the optical device is a ring resonator. A coupling wavelength for the ring resonator may be modulated by the stress structure. In some embodiments, the PIC includes a plurality of ring resonators having a range of distinct coupling wavelengths, wherein the differences in the coupling wavelengths are determined by differences in the stress fields modulated by stress structures associate with the ring resonators.

In some embodiments, the optical device is a mode converter. In some embodiments, the mode converter is made operative by stress structures. In particular, a transition between TM mode preferred and TE mode preferred between one end of the mode converter and the other results from a variation in a stress field that is related to a variation in a distribution of stress structure components between one end of the mode converter and the other. The distribution of stress components may be variable in terms of number of components, proximity of the components to the mode converter, height of the components, width of the components, or the like.

In some embodiments, the stress structures comprise islands symmetrically disposed on two opposite sides of the mode converter. In some of these embodiments, there are a plurality of islands on each of the two opposite sides at a given position along a length of the mode converter. The instantiation of these islands may vary along the length so that their number varies along the length. In some embodiments, there is a variation in height or width among the islands at a given position along the length. These variations in the dimensions of the islands in conjunction with a variation in their instantiation along the length of the mode converter facilitates providing an approximately linear variation in the refractive index along the length, which makes the mode converter more efficient.

Some aspects of the present disclosure relate to methods of manufacturing a PIC device with stress structures. The methods may begin with providing a substrate. In some embodiments, the substrate is a BOX substrate. A PIC is formed by processing that includes etching the top layer and depositing cladding over the top layer. A metal interconnect structure with electrical connections to the PIC may be formed over the cladding.

In some embodiments, forming a stress structure includes etching and filling a hole. In some embodiments, the hole is formed in the top layer so that the stress structure is embedded in the top layer. In some embodiments the hole is formed in the cladding. In some embodiments, the hole is formed in an interlevel dielectric of the metal interconnect structure. In some embodiments, a hole formed in the interlevel dielectric extends downward into the cladding.

In some embodiment, the hole is refilled with the same type of material that was etched from the hole. In some embodiments, the hole is formed in silicon dioxide (SiO₂) and is refilled with a silicon oxide (SiOₓ). In some embodiments, the hole is formed in silicon nitride (Si₃N₄) and is refilled with a silicon nitride (SiₓN_{y}). In some embodiments, the hole is formed in semiconductor and is refilled with a semiconductor. Using the same type of material for refill may improve optical performance. A difference in deposition conditions between the original material and the replacement material, e.g., a difference in deposition rate, may provide a difference in coefficient of thermal expansion with respect to the original and replacement materials. In some embodiments, the replacement material differs from the original material in atomic ratio.

In alternative embodiments, the refill material has a distinct composition from the original material. Using a distinct composition facilitates providing a desired CTE difference with the surrounding material. The difference in composition may also facilitate providing stress structures with rounded upper surfaces. The rounding of the upper surfaces may be achieved using chemical mechanical polishing (CMP) provided that the refill material and the surrounding material have different polishing rates. In some embodiments, forming the stress structure comprises depositing a porous material. In some embodiments, forming the stress structure comprises a sol-gel technique. The sol-gel technique allows formation of a material with a precisely controlled porosity and CTE.

In some embodiments, the stress structure is formed by ion implantation. In some embodiments, the ion implantation is followed by annealing. Ion implantation and annealing provide a stress structure that shares a composition and has similar optical properties to the surrounding material while having a distinct density or crystal structure. In some embodiments, the ions are implanted in the top layer. In some embodiments, the ions are ions of silicon (Si) or the like. In some embodiments, the ions are implanted in the cladding. In some embodiments, the ions are ions of nitrogen (N), xenon (Xe), argon (Ar) or the like.

In some embodiments, the stress structure is formed by laser annealing. Laser annealing is another method of forming a stress structure that shares a composition and has similar optical properties to the surrounding material while having a distinct CTE, density, or crystal structure. In some embodiments, the laser annealing is applied to a material having a lattice structure, e.g., the top layer. In some embodiments, the laser annealing is applied to an amorphous structure, e.g., the cladding.

In some embodiments, the stress structure is provided by dummy metal in the metal interconnect structure. Dummy metal may be formed using the same processing used to provide functional metal. Unlike conventional dummy metal structures of the type used to prevent dishing during CMP, the locations for the dummy metal that comprises a stress structure is determined with reference to the locations of an optical device. In some embodiments, the dummy metal structures are symmetrically arranged with respect to the optical device. In some embodiments, the dummy metal structures comprise a row of islands that extends parallel to a light transmission pathway of the optical device.

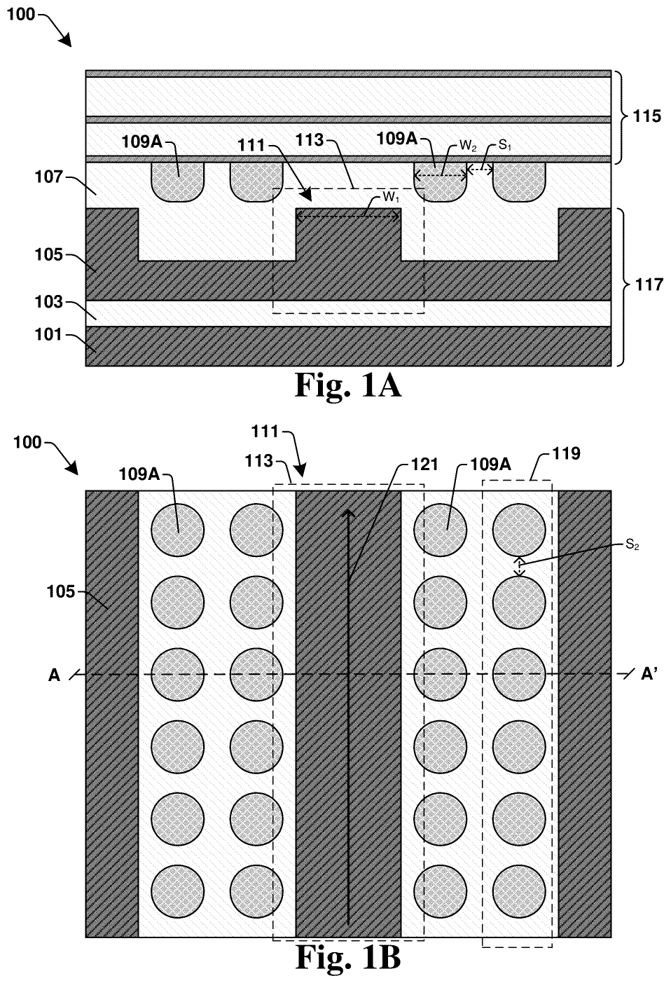

FIG. 1A illustrates a cross-sectional view of PIC device 100. FIG. 1B illustrates a plan view of the PIC device 100. The PIC device 100 includes a waveguide 111 with cladding 107. The waveguide 111 is of the rib-type and may be formed in a top layer 105 of a BOX substrate 117. The BOX substrate 117 includes a handle substrate 101, a buried oxide layer 103, and the top layer 105. Cladding 107 is disposed over the BOX substrate 117 and a metal interconnect structure 115 may be disposed over the cladding 107.

A stress structure 109A comprising a plurality of islands of material having intrinsic stress is embedded within the cladding 107 and exert stress on an optical propagation region (OPR) 113 associated with the waveguide 111. The stress alters refractive indexes within the optical propagation region 113 and in particular within the waveguide 111. The magnitude of the alteration may be sufficient to affect whether the waveguide 111 is TM mode preferred or TE mode preferred.

The stresses vary a refractive index in the waveguide 111 by at least about 5×10⁻⁵. In some embodiments, the refractive index is changed by at least about 25×10⁻⁵. Changes in refractive index of these magnitudes may be sufficient to affect whether the waveguide 111 is TM mode preferred or TE mode preferred. The refractive index changes are anisotropic and may be realized over a portion of the OPR 113 comprising from about 5% to about 100% of the OPR 113 in a cross-section perpendicular to a light transmission direction 121 for the waveguide 111. In some embodiments, the stress structure 109A alters a pressure in the OPR by at least about 100 MPa. Pressures in that range may provide one of the foregoing refractive index changes. The foregoing ranges are applicable to any of the stress structures and optical devices of the present disclosure. The stresses, strains, and refractive index changes that are the subject of this disclosure may be determined by mathematical modeling. The prediction of a mathematical model may be experimentally confirmed with techniques such as x-ray diffraction, Raman spectroscopy, and the like.

The waveguide 111 may have a width W₁ in the range from about 1 μm to about 10 μm. In some embodiments, the islands of the stress structure 109A have widths W₂ that are in the range from about 1 μm to about 10 μm. In some embodiments, the widths W₂ that are less than the width W₁. In some embodiments, the islands of the stress structure 109A have a spacing Si (between rows 119) or a spacing S₂ (within a row 119) in the range from about 1 μm to about 5 μm. In some embodiments, the spacing Si or the spacing S₂ is less than about 1 μm. These sizes are suitable for creating local stresses that enhance optical devices while avoiding stresses that cause warping or cracking.

In some embodiments, the islands of the stress structure 109A share a composition with the cladding 107. In some embodiments, the stress structure 109A has the composition of the cladding 107 plus additional material. In some embodiments, the stress structure 109A has the composition of the cladding 107 but has a difference in density or crystal structure. In some embodiments, the stress structure 109A has a molecular composition that is the same as that of the cladding 107 except for a difference in atomic ratio. Alternatively, the islands of the stress structure 109A may have an entirely different composition from the cladding 107.

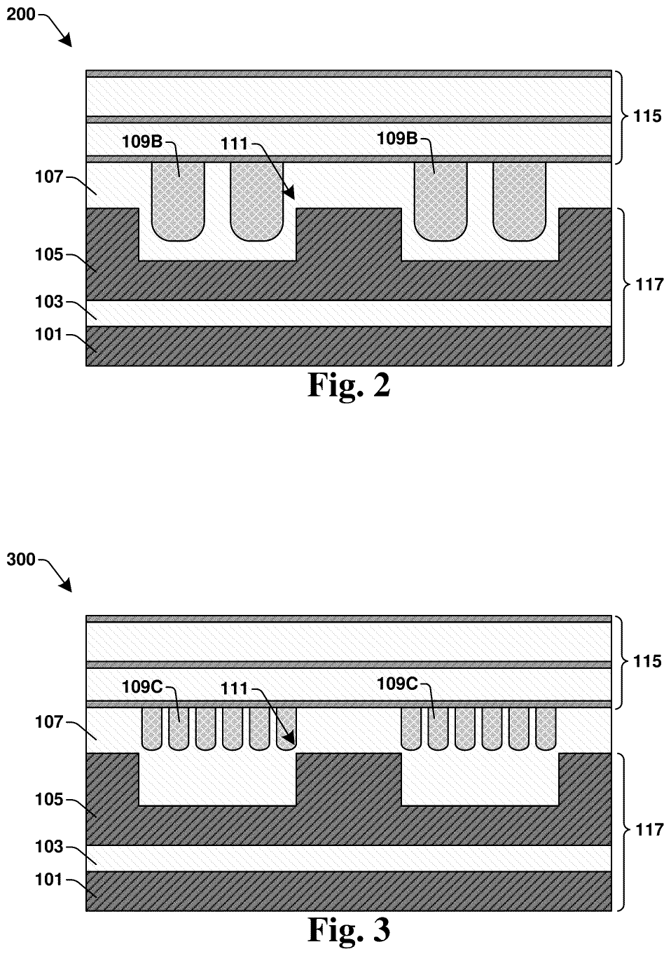

FIG. 2 illustrates a cross-sectional view of a PIC device 200 having a stress structure 109B in accordance with another embodiment. Whereas the islands of the stress structure 109A of FIG. 1A are disposed at an elevation above the waveguide 111, the islands of the stress structure 109B of FIG. 2 descend so that that parts of the stress structure 109B are coplanar with (at the same elevation as) the waveguide 111. The stress structure 109B may apply larger forces to the waveguide 111 than the stress structure 109A. On the other hand, the stress structure 109A, which is confined at or above the height of the waveguide 111, may be less susceptible to causing interference with optical transmission.

FIG. 3 illustrates a cross-sectional view of a PIC device 300 having a stress structure 109C in accordance with another embodiment. The stress structure 109C is like the stress structure 109A of FIG. 1 except that whereas the stress structure 109A comprises four rows of islands, two on each side of the waveguide 111, the stress structure 109C comprises twelve rows of islands, six on each side of the waveguide 111. For symmetrical stress structures, there may be from 1 to about 10 rows of island on each side of the waveguide 111. In some embodiments, the stress structure is asymmetric with respect to the waveguide 111 or other optical device. Any of the illustrated stress structures may be made asymmetric by eliminating the islands on one side of the optical device.

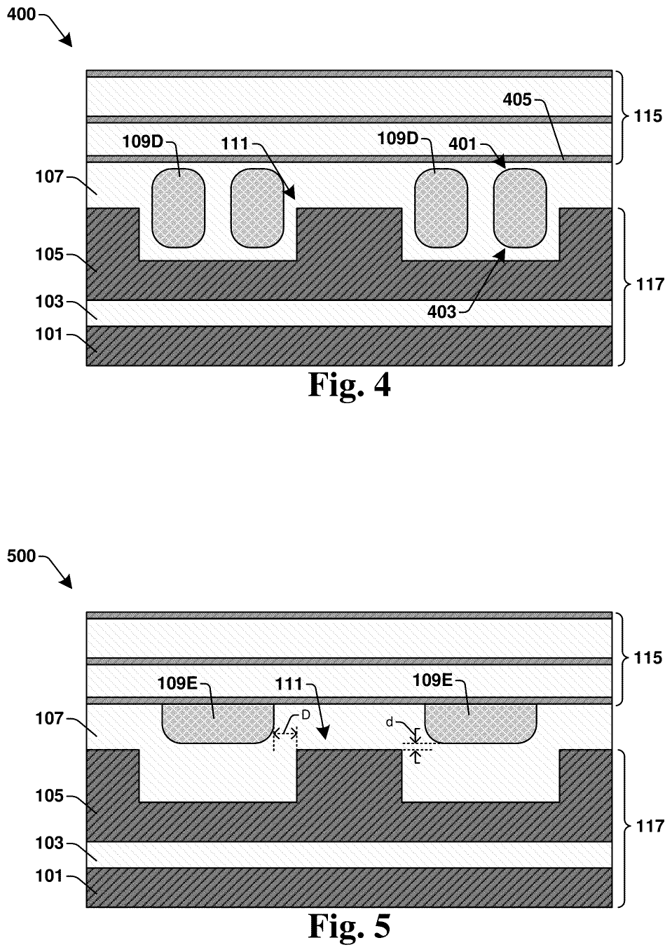

FIG. 4 illustrates a cross-sectional view of a PIC device 400 having a stress structure 109D in accordance with another embodiment. The stress structure 109D is like the stress structure 109B of FIG. 2 except that the islands of the stress structure 109D have rounded upper surfaces 401 in addition to rounded lower surfaces 403. The stress structure 109D may be fully embedded within the cladding 107 as opposed to having upper surfaces that abut the etch stop layer 405 at the base of the metal interconnect structure 115.

FIG. 5 illustrates a cross-sectional view of a PIC device 500 having a stress structure 109E in accordance with another embodiment. The stress structure 109E is like the stress structure 109A of FIG. 1, except that the stress structure 109E comprises wider islands arranged in two rows one on each side of the waveguide 111. Stress structures may be directly over, directly under, or to the side of the waveguide 111. Where they are to the side, they may be spaced from the waveguide 111 by a distance D. In some embodiments, the distance D is in the range from about 1 μm to about 20 μm. In some embodiments, the distance D is about 1 μm or less. In some embodiments, the stress structure contacts the waveguide 111 or other optical device. Direct contact can provide greater stress, but in some instances direct contact may interfere with optical transmission. In some embodiments where a stress structure is elevated above the waveguide 111 or other optical device by a distance d, the distance d is in the range from about 0 μm to about 2 μm.

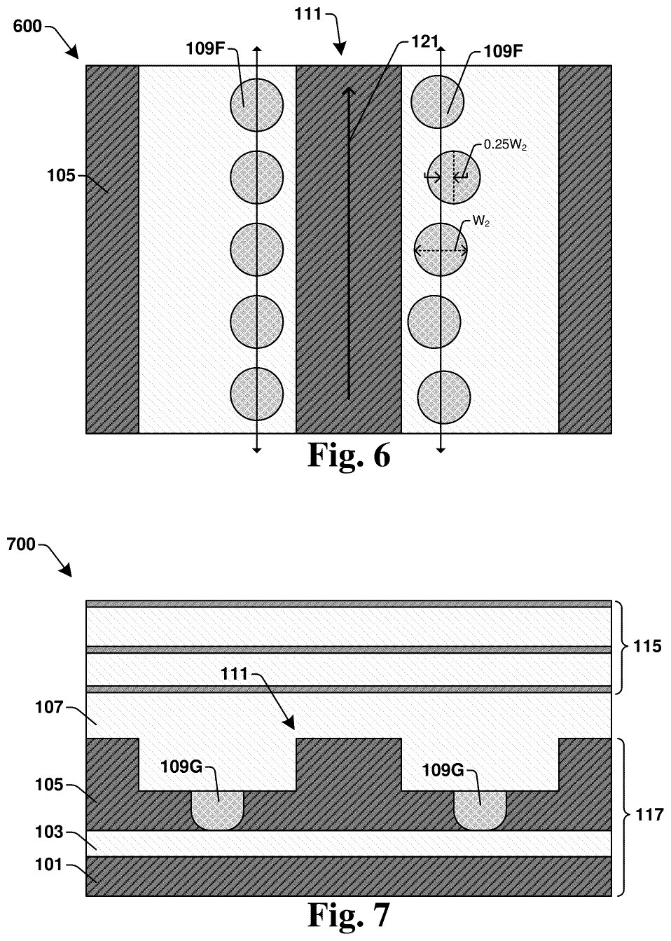

FIG. 6 illustrates a plan view of PIC device 600 having a stress structure 109F in accordance with another embodiment. The stress structure 109F illustrates the possibility of variability in the positioning of individual islands in a group of islands making up a stress structure. The islands of a stress structure may be spaced along a transmission direction 121 of the waveguide 111 to avoid over concentration of stresses. The periodic spacing provides a generally uniform stress pattern, although an oscillation in the stress pattern along the transmission direction 121 is discernable. Periodic spacing is desirable to keep the stresses uniform along the transmission direction 121, but some uncertainty in the positions of the individual islands is tolerable. In some embodiments, individual islands in a row of islands in a stress structure are allowed to deviate from an ideal periodic spacing by an amount less than or equal to about 25% of W₂, the width of the islands. The deviation may be in any direction, e.g., along the transmission direction of the waveguide 111 or perpendicular to the transmission direction of the waveguide 111.

FIG. 7 illustrates a plan view of PIC device 700 having a stress structure 109G in accordance with another embodiment. The stress structure 109G comprises rows of islands embedded in the top layer 105. The islands of the stress structure 109G may share a composition with the top layer 105 or may have an entirely different composition. In some embodiments, the stress structure 109G has the composition of the top layer 105 plus additional material. In some embodiments, the stress structure 109G has the composition of the top layer 105 but has a difference in density or crystal structure. In some embodiments, the stress structure 109G and the top layer 105 are both semiconductors.

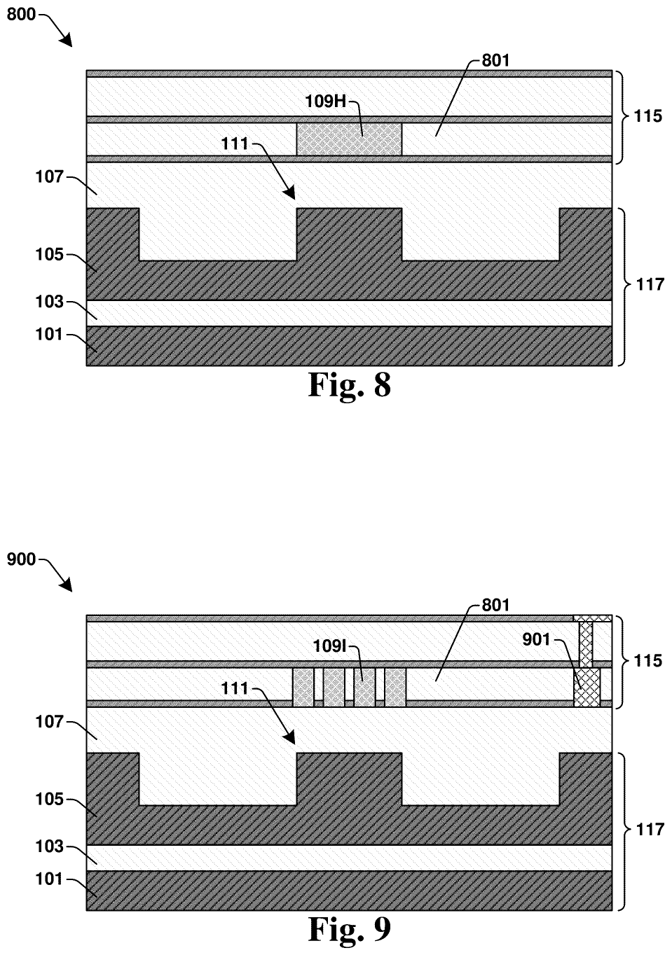

FIG. 8 illustrates a cross-sectional view of a PIC device 800 having a stress structure 109H in accordance with another embodiment. The stress structure 109H comprises islands embedded in an interlevel dielectric 801 of the metal interconnect structure 115. The stress structure 109H may be directly above the waveguide 111. In some embodiments, the stress structure 109H comprises a composition of the interlevel dielectric 801.

FIG. 9 illustrates a cross-sectional view of a PIC device 900 having a stress structure 109I in accordance with another embodiment. The stress structure 109I also comprises rows of islands embedded in the interlevel dielectric 801. In some embodiments, the stress structure 109I is composed of dummy metal having the same composition as a wire 901 of the metal interconnect structure 115. In some embodiments, the stress structure 109I has the composition of the interlevel dielectric 801 plus additional material. In some embodiments, the stress structure 109I has the composition of the interlevel dielectric 801 but differs from the interlevel dielectric 801 in density or crystal structure.

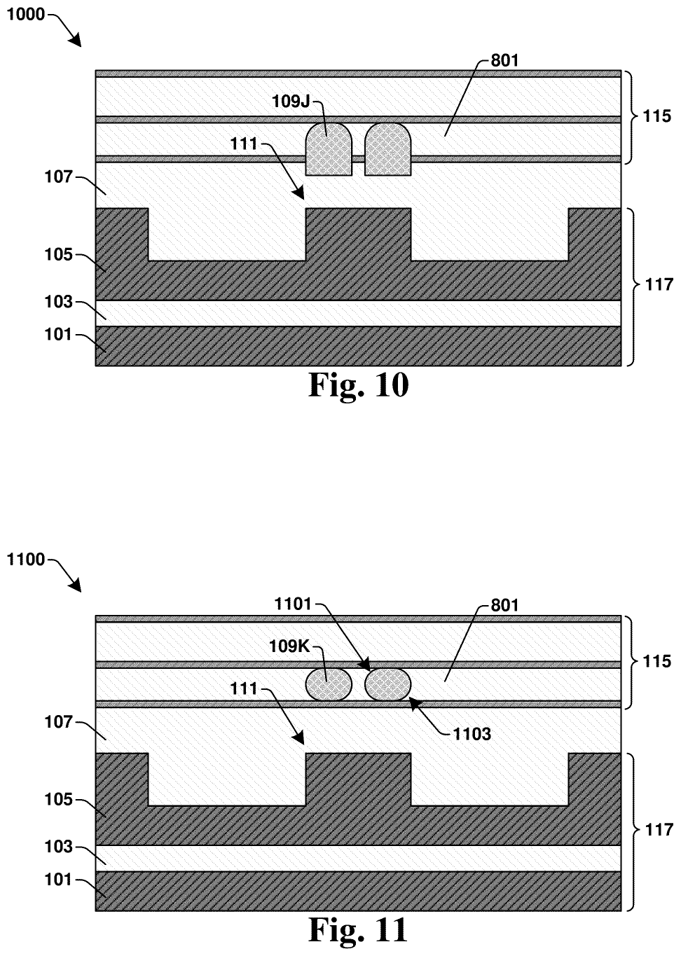

FIG. 10 illustrates a cross-sectional view of a PIC device 1000 having a stress structure 109J in accordance with another embodiment. The stress structure 109J comprises rows of islands embedded in the interlevel dielectric 801. The islands of the stress structure 109J extend downward into the cladding 107 so that the stress structure 109J is also embedded in the cladding 107.

FIG. 11 illustrates a cross-sectional view of a PIC device 1100 having a stress structure 109K in accordance with another embodiment. The stress structure 109K comprises rows of islands embedded in the interlevel dielectric 801. The islands of the stress structure 109K have rounded upper surfaces 1101 of a type that may be produced by chemical mechanical polishing (CMP) and rounded lower surface 1103 of a type that may be produced by a damascene process when etching is relatively isotropic.

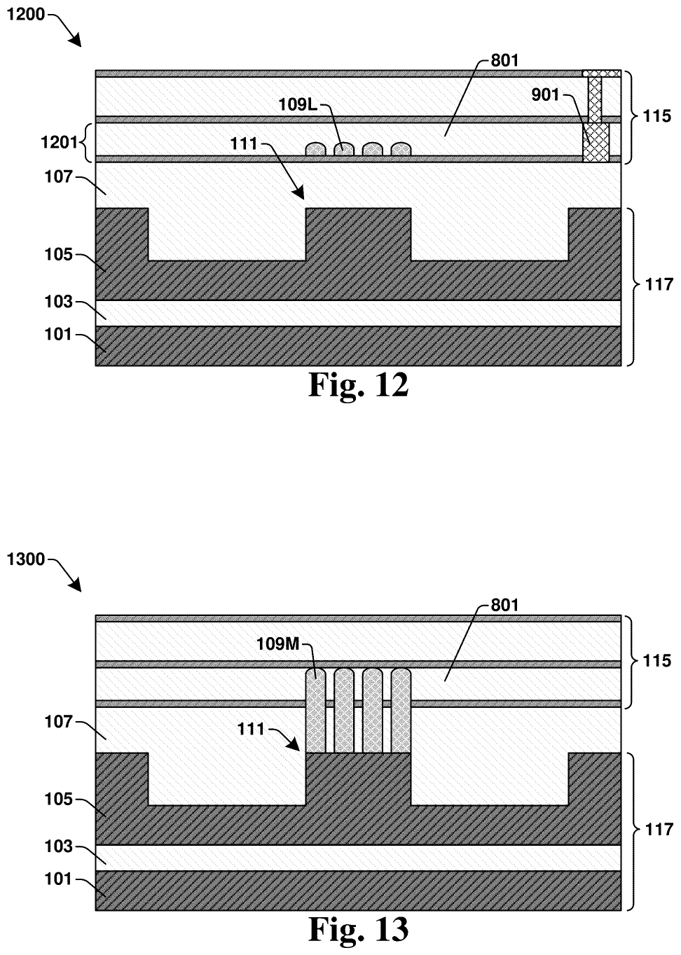

FIG. 12 illustrates a cross-sectional view of a PIC device 1200 having a stress structure 109L in accordance with another embodiment. The stress structure 109L comprises rows of islands embedded in an interlevel dielectric 801 of the metal interconnect structure 115. The stress structure 109L is in the same metallization layer 1201 as the wires 901 but is shorter than the wires 901 and has a distinct composition.

FIG. 13 illustrates a cross-sectional view of a PIC device 1300 having a stress structure 109M in accordance with another embodiment. The stress structure 109M comprises islands directly above the waveguide 111 and in direct contact with a top of the waveguide 111. The stress structure 109M may be embedded in both the interlevel dielectric 801 and in the cladding 107.

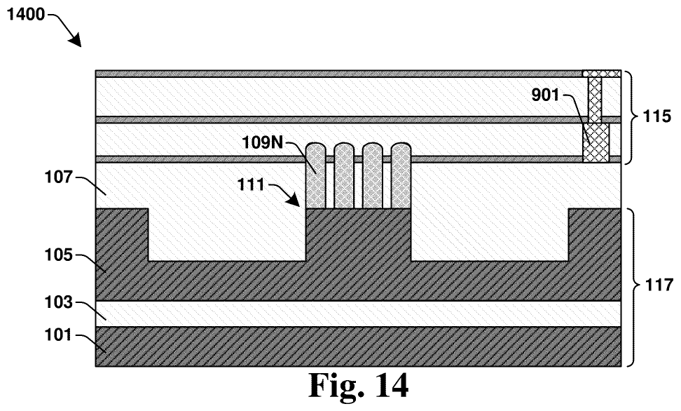

FIG. 14 illustrates a cross-sectional view of a PIC device 1400 having a stress structure 109N in accordance with another embodiment. The stress structure 109N is like the stress structure 109M of FIG. 13 but has a lower height.

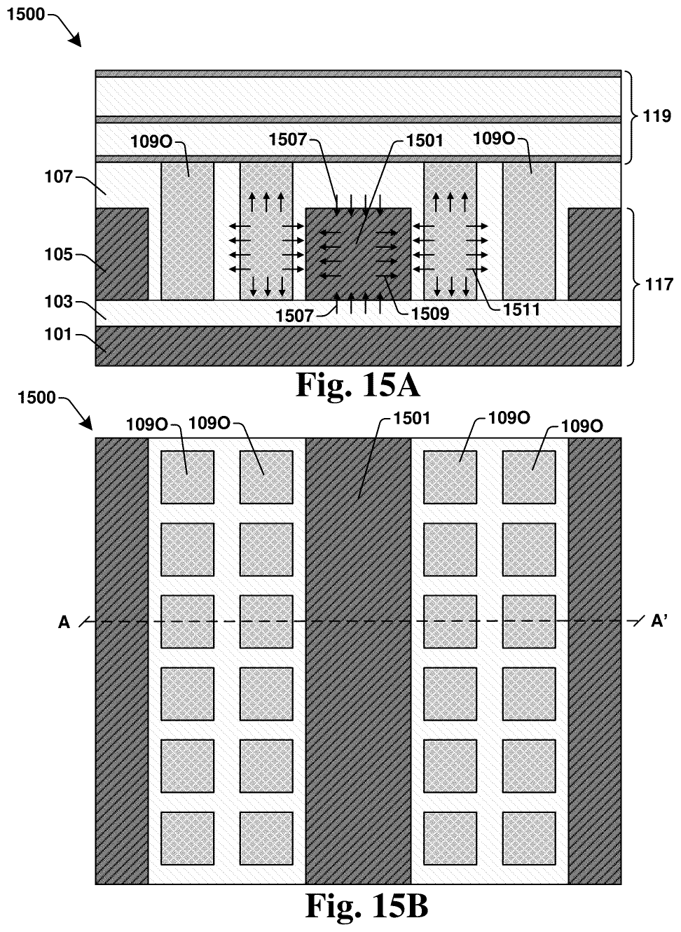

FIG. 15A illustrates a cross-sectional view and FIG. 15B illustrates a plan view of a PIC device 1500 having a stress structure 109O in accordance with another embodiment. The PIC device 1500 comprises the waveguide 1501. The waveguide 1501 is of the strip type. The stress structure 109O has a higher CTE than the surrounding material (cladding 107). The higher CTE means greater contraction upon cooling from a manufacturing temperature so that the material surrounding the islands of the stress structure 109O places tensile stress 1511 on the islands of the stress structure 109O. The tensile stress 1511 is transmitted through the cladding 107 and the waveguide 1501 so that tensile stress 1509 is applied to the sides of the waveguide 1501. The tensile stress 1509 causes compressive stress 1507 on the top and bottom of the waveguide 1501. The tensile stress 1509 on the sides of the waveguide 1501 increases the index of refraction in the horizontal direction and the compressive stress 1507 on the top and bottom of the waveguide reduces the index of refraction in the vertical direction. The overall effect is to cause the waveguide 1501 to become TE mode preferred.

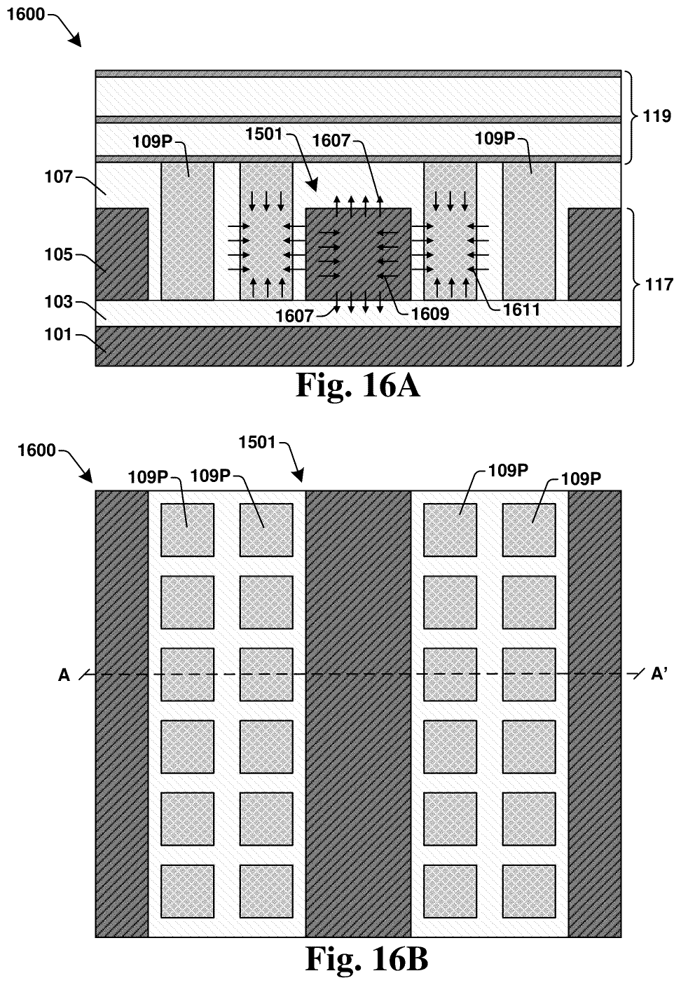

FIG. 16A illustrates a cross-sectional view and FIG. 16B illustrates a plan view of a PIC device 1600 having a stress structure 109P in accordance with another embodiment. The PIC device 1600 comprises the waveguide 1501. The stress structure 109P has a lower CTE than the surrounding material (cladding 107). The lower CTE means less contraction upon cooling from a manufacturing temperature so that the material surrounding the islands of the stress structure 109P places compressive stress 1611 on the islands of the stress structure 109P. The compressive stress 1611 is transmitted through the cladding 107 and the waveguide 1501 so that compressive stress 1609 is applied to the sides of the waveguide 1501. The compressive stress 1609 causes tensile stress 1607 on the top and bottom of the waveguide 1501. The compressive stress 1609 on the sides of the waveguide 1501 reduces the index of refraction in the horizontal direction and the tensile stress 1607 on the top and bottom of the waveguide increases the index of refraction in the vertical direction. The overall effect is to cause the waveguide 1501 to become TM mode preferred.

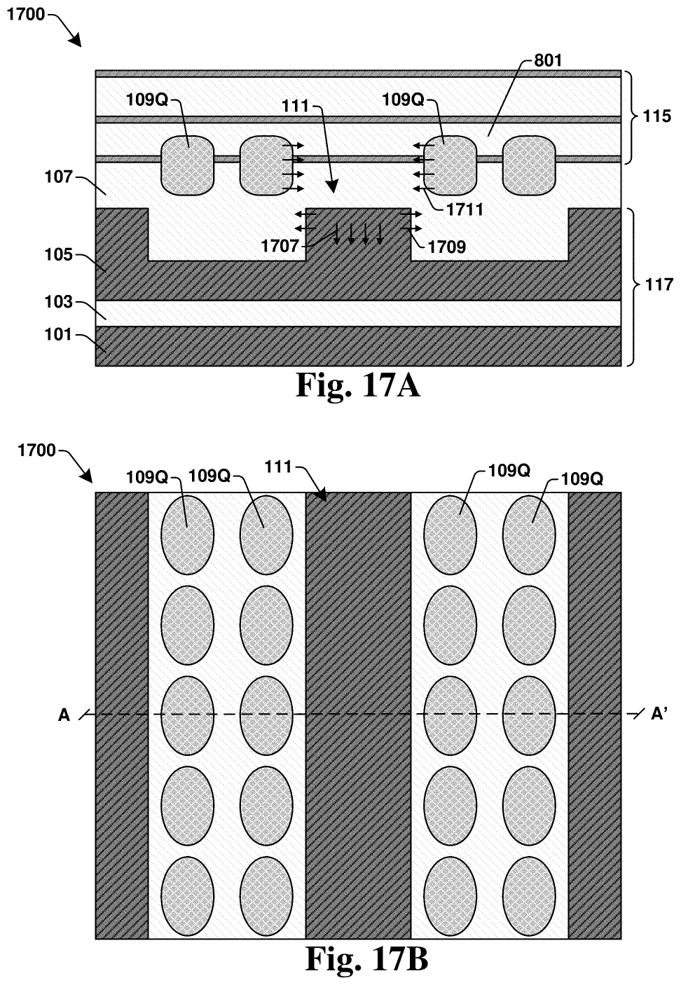

FIG. 17A illustrates a cross-sectional view and FIG. 17B illustrates a plan view of a PIC device 1700 having a stress structure 109Q in accordance with another embodiment. The PIC device 1500 comprises the waveguide 111. The stress structure 109Q 1901 has a higher CTE than the surrounding material (cladding 107 and interlevel dielectric 801) so that the material surrounding the islands of the stress structure 109Q places tensile stress 1711 on the islands of the stress structure 109Q. The tensile stress 1711 is transmitted through the intervening material so that tensile stress 1709 is applied to the sides of the waveguide 111. In addition, compressive stress 1707 (shear stress) occurs within the waveguide 111. The tensile stress 1709 on the sides of the waveguide 111 increases the index of refraction in the horizontal direction and the compressive stress 1707 in the vertical direction reduces the index of refraction in the vertical direction. The overall effect is to cause the waveguide 111 to become TE mode preferred.

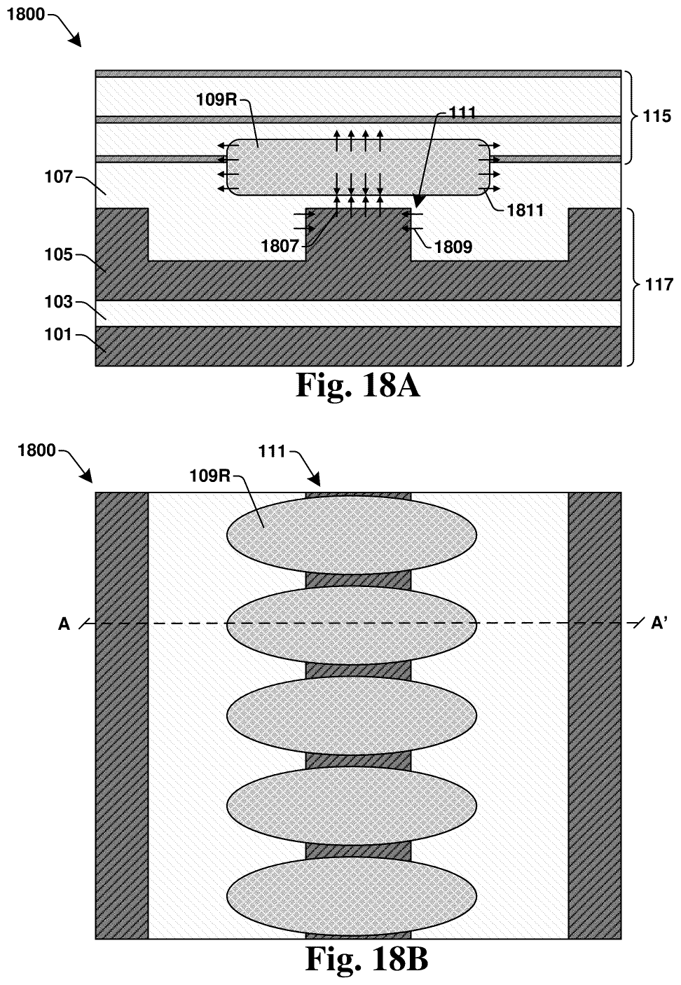

FIG. 18A illustrates a cross-sectional view and FIG. 18B illustrates a plan view of a PIC device 1800 having a stress structure 109R in accordance with another embodiment. The PIC device 1500 comprises the waveguide 111. The stress structure 109R has a higher CTE than the surrounding material (cladding 107 and interlevel dielectric 801) so that the material surrounding the islands of the stress structure 109R places tensile stress 1811 on the islands of the stress structure 109R. The tensile stress 1811 is transmitted through the intervening material so that tensile stress 1807 is applied to the top of the waveguide 111. Compressive stress 1809 (shear stress) results on the sides of the waveguide 111. The compressive stress 1809 on the sides of the waveguide 11 reduces the index of refraction in the horizontal direction and the tensile stress 1811 on the top of the waveguide 111 increases the index of refraction in the vertical direction. The overall effect is to cause the waveguide 111 to become TM mode preferred.

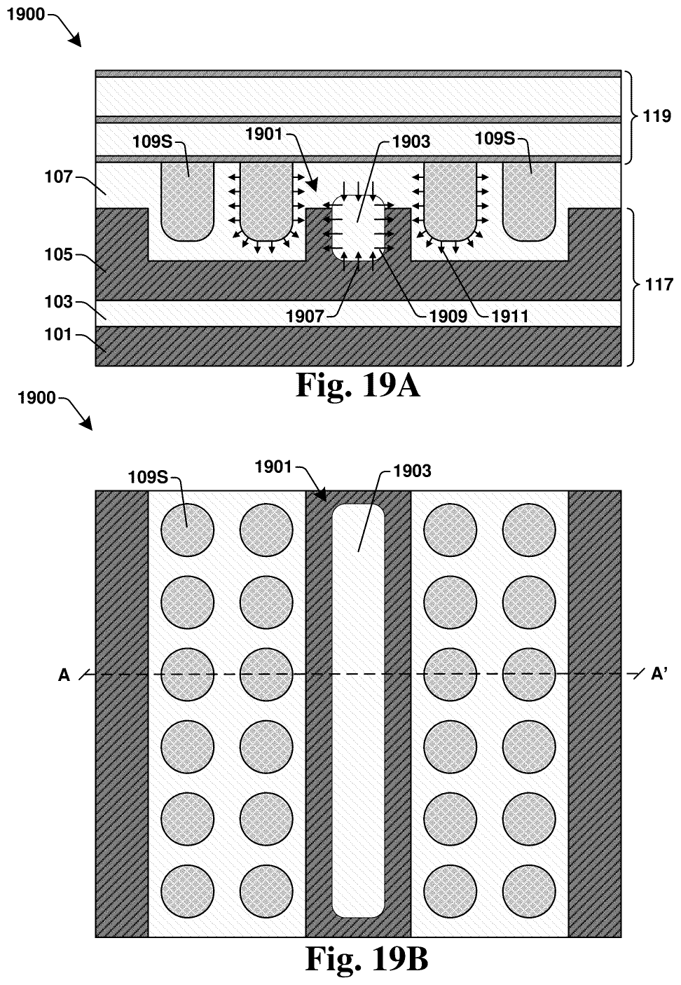

FIG. 19A illustrates a cross-sectional view and FIG. 19B illustrates a plan view of a PIC device 1900 having a stress structure 109S in accordance with another embodiment. The PIC device 1900 comprises photodiode 1901. The photodiode 1901 may include a germanium structure 1903 within a portion of the top layer 105 having a structure similar to a waveguide. The stress structure 109S comprises islands of material under tensile stress 1911. The tensile stress 1911 is transmitted through the cladding 107 and the top layer 105 so that tensile stress 1909 is applied to the sides of the germanium structure 1903. In addition, compressive stress 1907 may result on the germanium structure 1903 in a vertical direction. The overall effect is to shift bandgap energies in the germanium structure 1903 and so the absorption spectrum for the photodiode 1901.

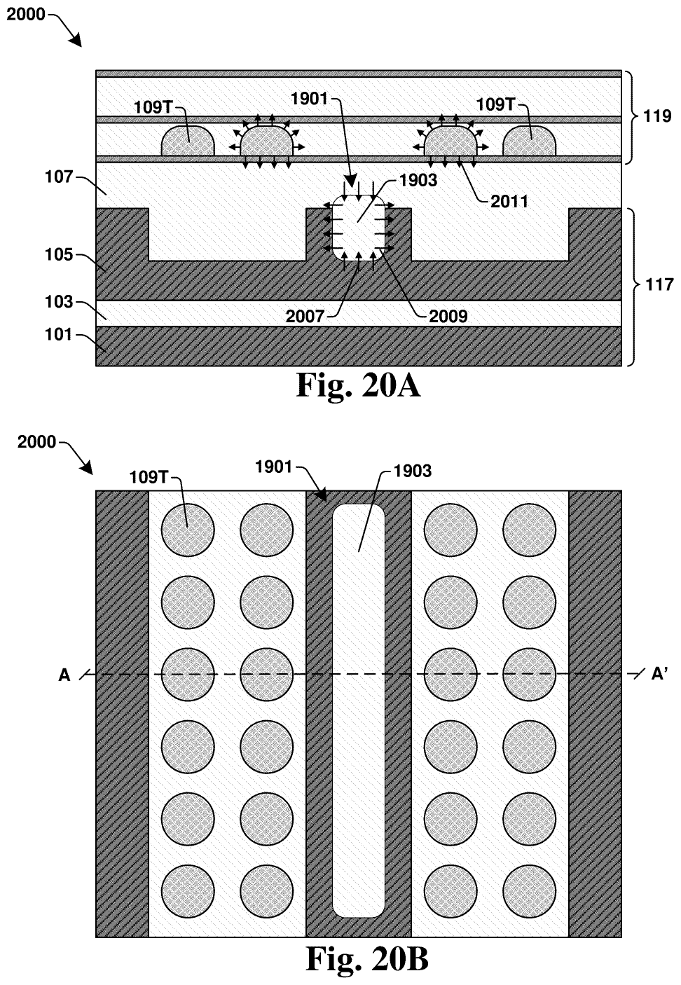

FIG. 20A illustrates a cross-sectional view and FIG. 20B illustrates a plan view of a PIC device 2000 having a stress structure 109T in accordance with another embodiment. The PIC device 2000 comprises the photodiode 1901. The stress structure 109T comprises islands of material under tensile stress 2011. The tensile stress 2011 is transmitted through the intervening materials so that tensile stress 2009 is applied to the sides of the germanium structure 1903. In addition, compressive stress 2007 may result on the germanium structure 1903 in a vertical direction. The overall effect is to shift bandgap energies in the germanium structure 1903 and so the absorption spectrum for the photodiode 1901. The shift may be different as compared to the shift that occurs in the PIC device 1900 of FIGS. 19A and 19B.

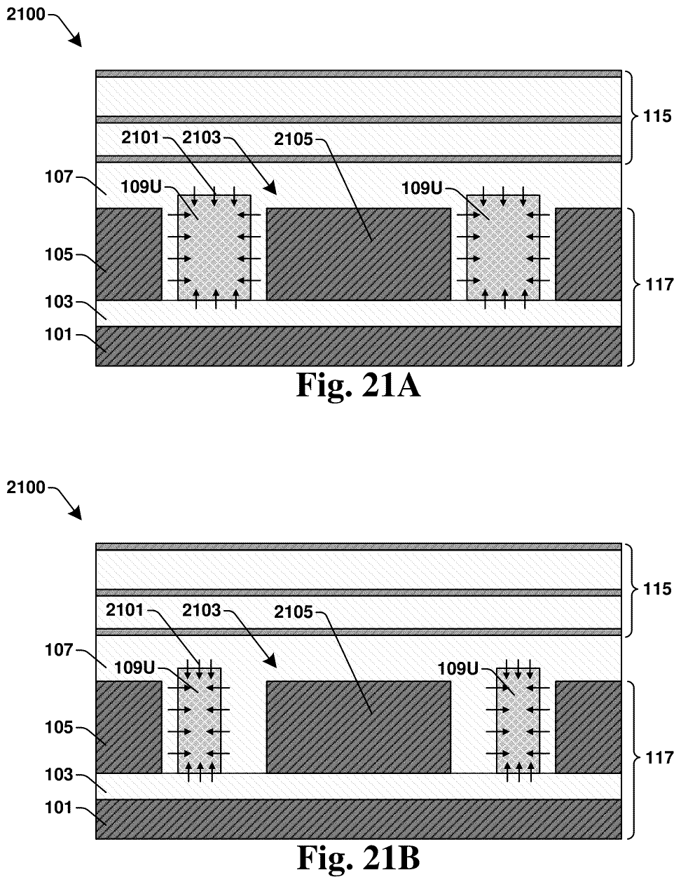

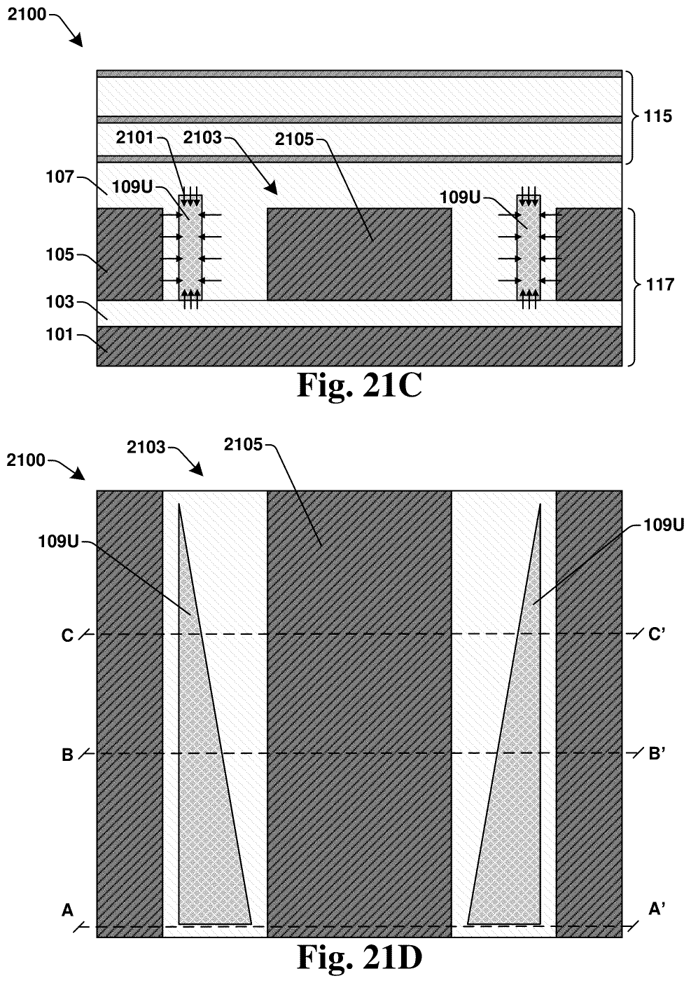

FIGS. 21A-21C illustrate a series of cross-sectional views and FIG. 21D illustrates a plan view of a PIC device 2100 that includes a mode converter 2103. The mode converter 2103 comprises a waveguide 2105 and a stress structure 109U comprising two islands on opposite sides of the waveguide 2105. The two islands of the stress structure 109U provide tensile stresses 2101. The stress structure 109U tapers in width along a length of the waveguide 2105 so that the stress applied to the waveguide 2105 varies along the length of the waveguide 2105. At the end where the stresses are highest, the waveguide 2105 is TM mode preferred. At the end where the stresses are lowest, the waveguide 2105 is TE mode preferred.

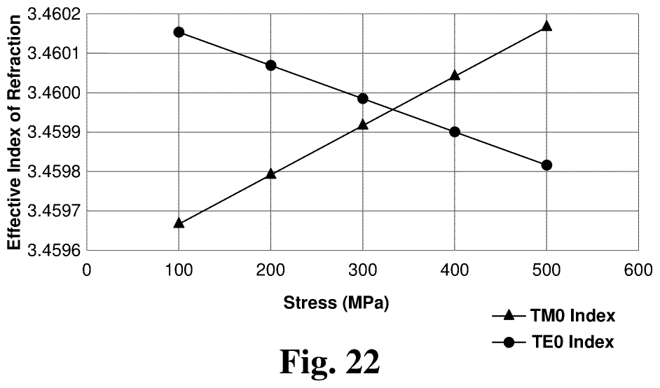

FIG. 22 provides a plot showing the effect of the magnitude of stress generated by an exemplary stress structure on refractive index for TE mode and TM mode transmission in an exemplary waveguide. As the stress increases from 100 MPa to 500 MPa, the TM mode refractive index increases by about 5×10⁻⁴ and the TE mode refractive index decreases by about 3.5×10⁻⁴. At 100 MPa, the TE mode refractive index is greater than the TM mode refractive index and the device is TE mode preferred. At 500 MPa, the TM mode refractive index is greater than the TE mode refractive index and the device is TM mode preferred.

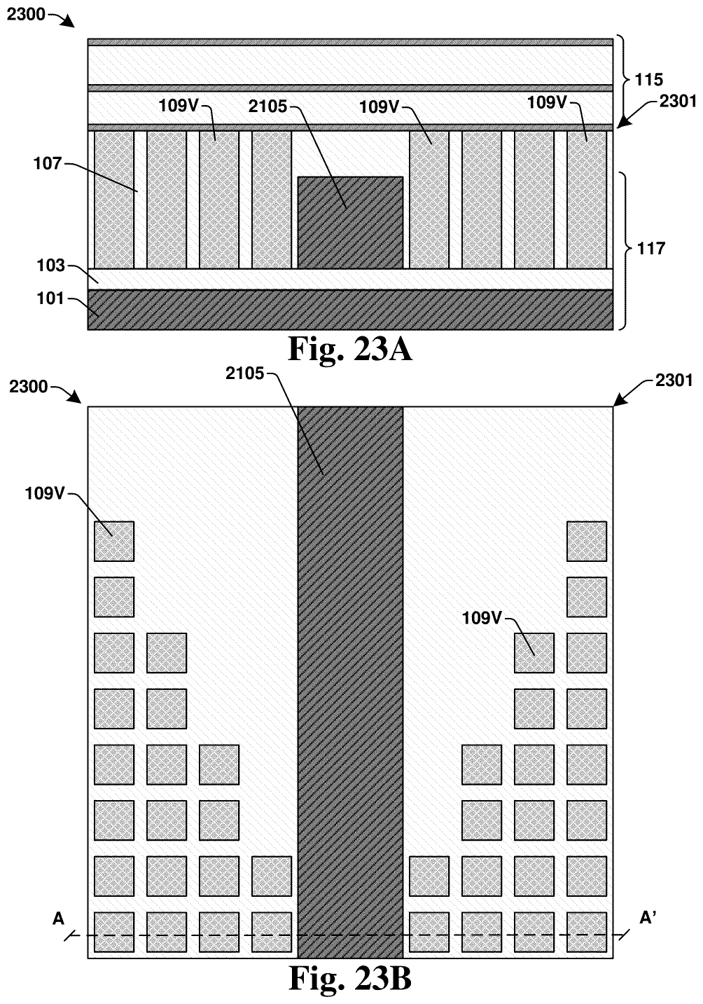

FIG. 23A illustrates a cross-sectional view and FIG. 23B illustrates a plan view of a PIC device 2300 that includes a mode converter 2301. The mode converter 2301 comprises the waveguide 2105 and a stress structure 109V. The stress structure 109V comprises eight rows of islands, two rows on each side of the waveguide 2105. The rows vary in length, with the rows closest to the waveguide 2105 being shortest. The variation in number of islands and their proximity to the waveguide 2105 along the length of the waveguide 2105 causes a transition between TE mode preferred and TM mode preferred along the length of the waveguide 2105.

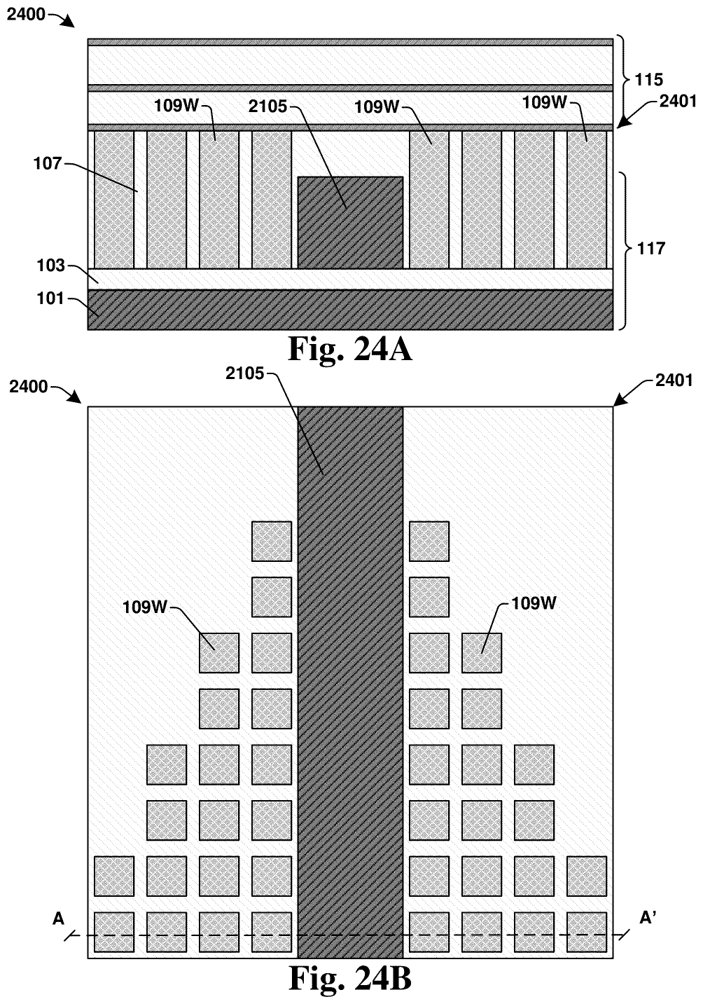

FIG. 24A illustrates a cross-sectional view and FIG. 24B illustrates a plan view of a PIC device 2400 that includes a mode converter 2401. The mode converter 2401 comprises the waveguide 2105 and a stress structure 109W. The stress structure 109W comprises eight rows of islands, two rows on each side of the waveguide 2105. The rows vary in length, with the rows furthest from the waveguide 2105 being shortest so that the number of islands to the side of the waveguide 2105 varies along a length of the waveguide 2105. The variation in number of islands effectuates a transition between TE mode preferred and TM mode preferred.

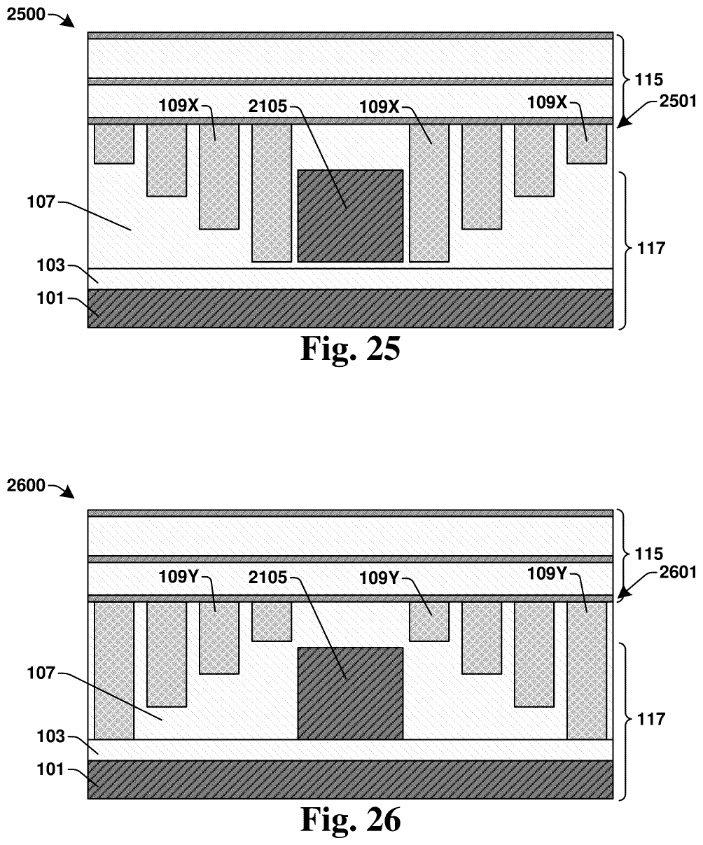

FIG. 25 illustrates a cross-sectional view of a PIC device 2500 that includes a mode converter 2501 having a stress structure 109X. The stress structure 109X may have the island layout of the stress structure 109V as shown in FIG. 23B or the layout of the stress structure 109W as shown in FIG. 24B. The stress structure 109X differs in that the islands of the stress structure 109X vary in depth so that the islands nearest the waveguide 2105 are deepest.

FIG. 26 illustrates a cross-sectional view of a PIC device 2600 that includes a mode converter 2601 having a stress structure 109Y. The stress structure 109Y may have the island layout of the stress structure 109V as shown in FIG. 23B or the layout of the stress structure 109W as shown in FIG. 24B. The stress structure 109Y differs in that the islands of the stress structure 109Y vary in depth so that the islands further from the waveguide 2105 are deepest. Either the stress structure 109V of FIGS. 23A-B, the stress structure 109W of FIGS. 24A-B, or a combination of one of those stress structures with the features of the stress structure 109X of FIG. 25 or 109Y of FIG. 26 may provide the highest efficiency mode converter for a given application. Computer simulations with experimental confirmation can determine which is best.

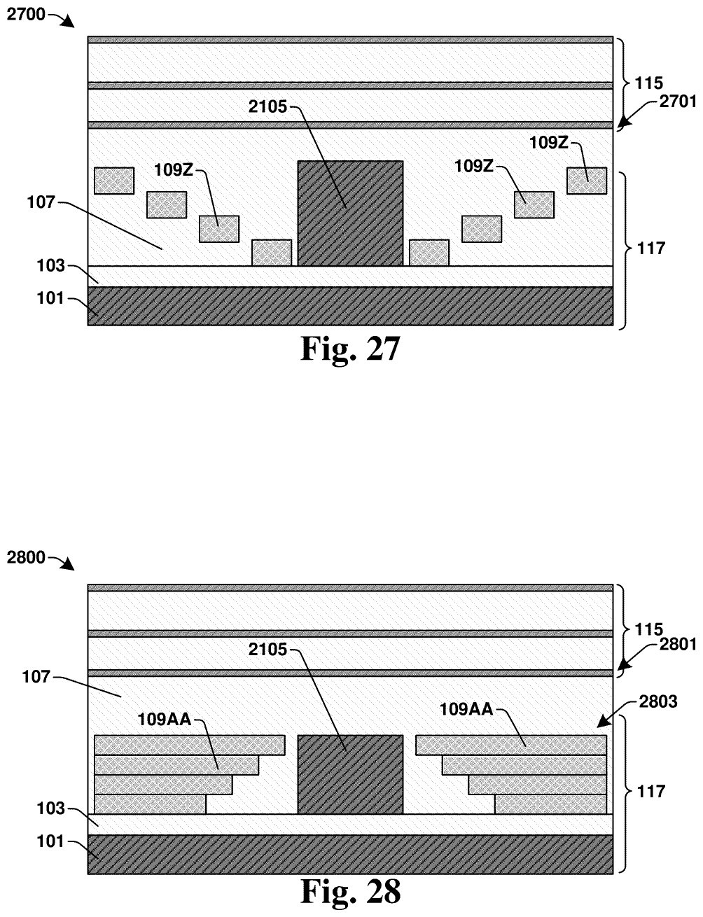

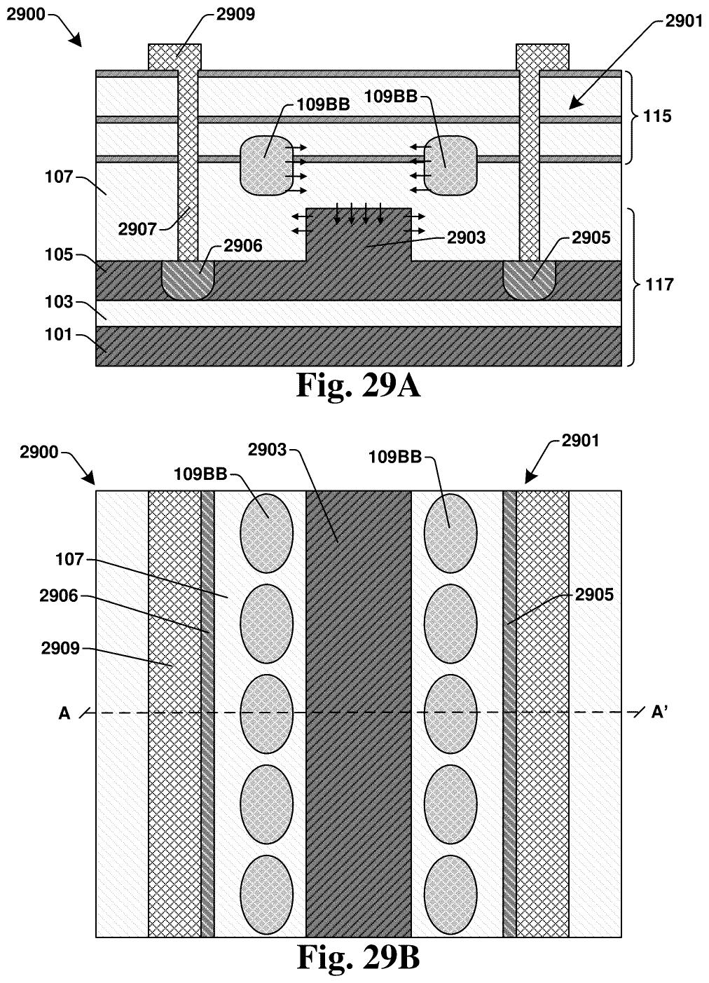

FIGS. 27 and 28 provide additional options for implementing a mode converter using stress variations along the length of a waveguide. FIG. 27 illustrates a cross-sectional view of a PIC device 2700 that includes a mode converter 2701 having a stress structure 109Z. The stress structure 109Z comprises islands that vary in distance from the waveguide 2105 and in a depth to which they are embedded in the cladding 107. The numbers and/or locations of these islands may be varied along a length of the waveguide 2105 to effectuate a transition between TE mode preferred and TM mode preferred.

FIG. 28 illustrates a cross-sectional view of a PIC device 2800 that includes a mode converter 2801 having a stress structure 109AA. The stress structure 109AA comprises staircase structures 2803. The stairs of the staircase structure 2803 may be wider on top, as in the illustrated cross-section, or wider on bottom. The stairs may be varied in number, length, or distance from the waveguide 2105 to effectuate a transition between TE mode preferred and TM mode preferred.

FIG. 29A illustrates a cross-sectional view and FIG. 29B illustrates a plan view of an IC device 2900 that includes a PiN modulator 2901 modified by a stress structure 109BB. The PIN modulator 2901 includes a waveguide 2903 between a P-doped region 2906 and an N-doped region 2905 in the top layer 105, which is a semiconductor. Contact pads 2909 are connected by wires 2907 to the P-doped region 2906 and the N-doped region 2905 so that a voltage between the P-doped region 2906 and the N-doped region 2905 may be controlled. Controlling the voltage controls the amplitude and phase of light passing through the waveguide 2903. The stress structure 109BB shifts the relationship between the voltage and the amplitude and phase of transmitted light and thereby provides an additional degree of freedom in the design of the PiN modulator 2901.

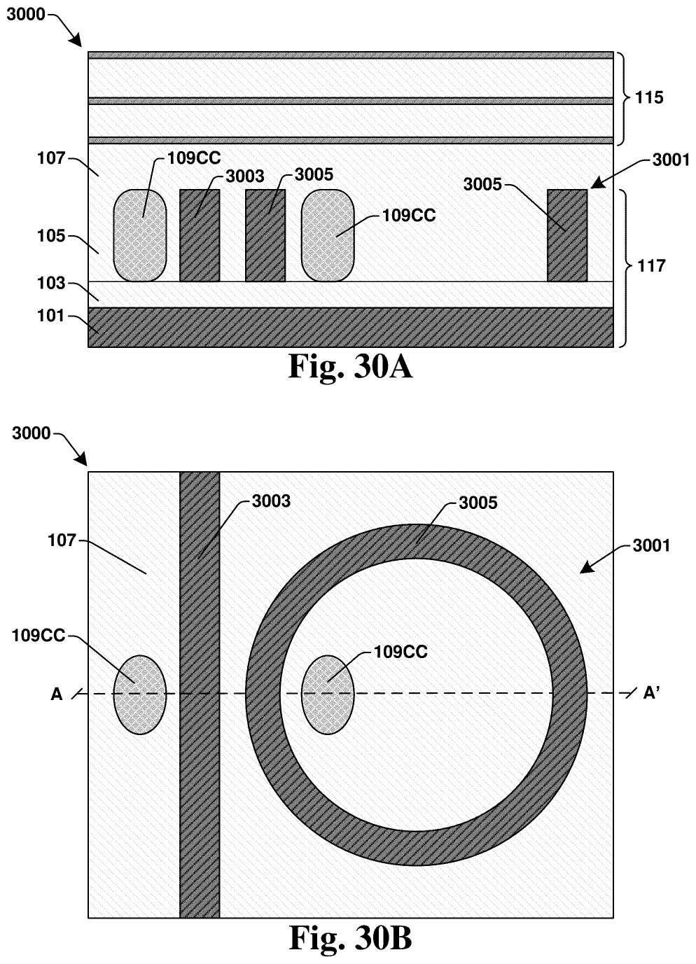

FIG. 30A illustrates a cross-sectional view and FIG. 30B illustrates a plan view of an IC device 3000 that includes a ring resonator 3001 modified by a stress structure 109CC. The ring resonator 3001 include a closed loop waveguide 3005 optically coupled to a straight waveguide 3003. A coupling wavelength for the ring resonator 3001 is modulated by the stress structure 109CC. The IC device 3000 may include a plurality of ring resonators 3001 that are alike except for differences in the stress structure 109CC. Those differences may be exploited to modulate, filter, convert, or otherwise manipulate optical signals over a range of wavelengths.

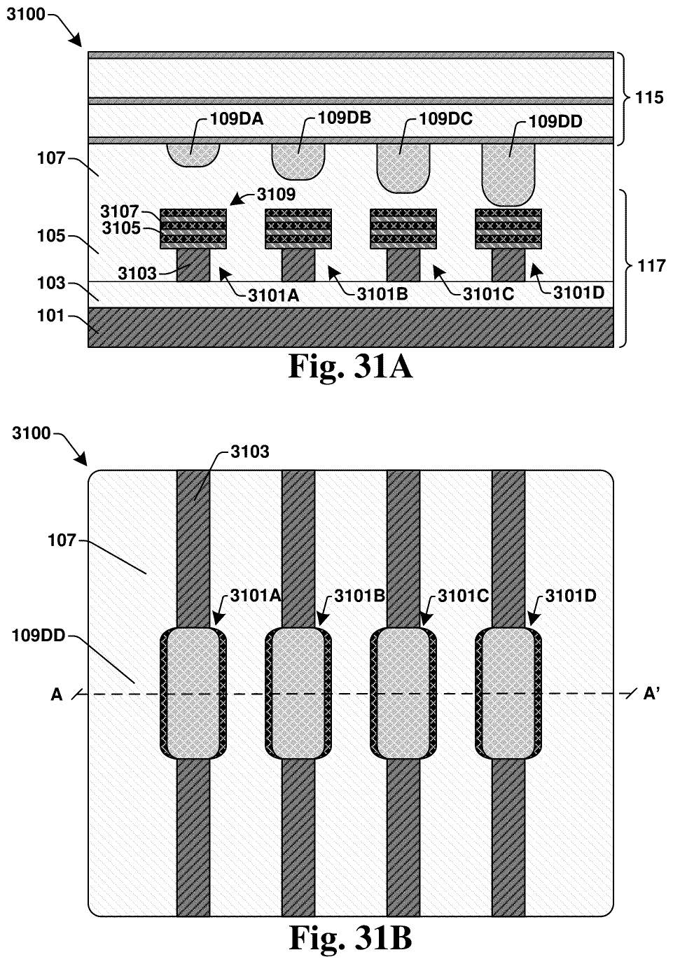

FIG. 31A illustrates a cross-sectional view and FIG. 31B illustrates a plan view of an IC device 3100 that includes a plurality of electro-absorption modulators 3101A-D modified by stress structure 109DA-DD. Each of the electro-absorption modulators 3101A-D includes a waveguide 3103 and a stack 3109 over the waveguide 3103. The stack 3109 may comprises quantum wells formed by alternating layers of a first semiconductor 3105 and a second semiconductor 3107. At least one layer in the stack 3109 may be configured as an electrode. The electro-absorption modulators 3101A-D have absorption spectrums modulated by the stress structure 109DA-DD. Differences among the stress structure 109DA-DD result in different absorption spectrums for each of the electro-absorption modulators 3101A-D.

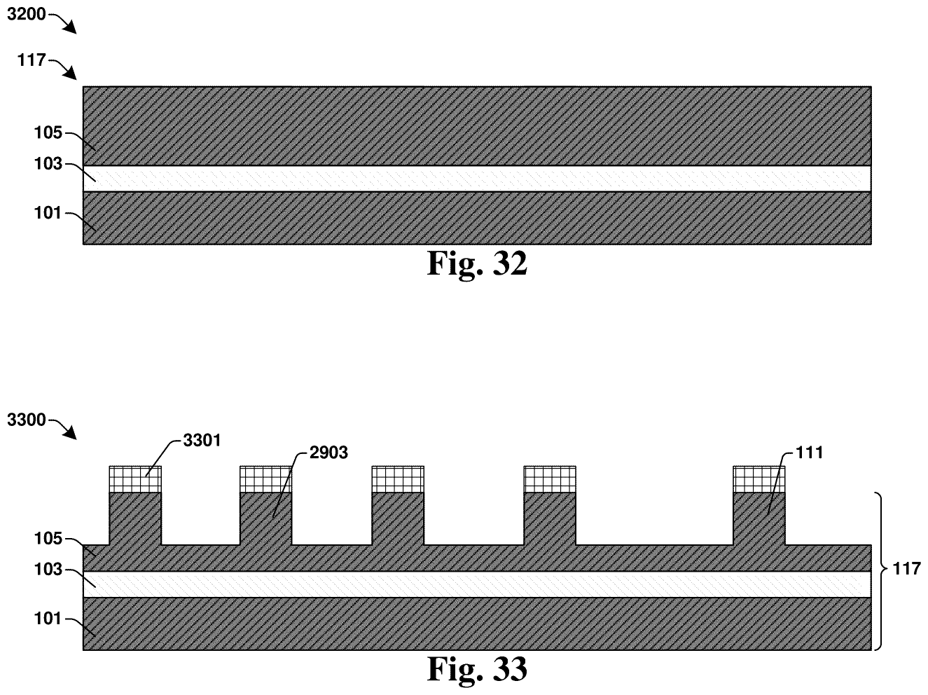

FIGS. 32-51 provide a series of cross-sectional views 3200-5100 illustrating a method of forming a PIC device with stress structures according to the present disclosure. While FIGS. 32-51 are described with reference to various embodiments of a method, it will be appreciated that the structures shown in FIGS. 32-51 are not limited to the method but rather may stand alone separate from the method. FIGS. 32-51 are described as a series of acts. The order of these acts may be altered in other embodiments. While FIGS. 32-51 illustrate and describe a specific set of acts, some may be omitted in other embodiments. Further, acts that are not illustrated and/or described may be included in other embodiments.

As shown by the cross-sectional view 3200 of FIG. 32, the method may begin by providing a BOX substrate 117. The BOX substrate 117 comprises the handle substrate 101, the oxide layer 103, and the top layer 105. The handle substrate 101 may be a material such as a glass, ceramic, sapphire, or a semiconductor. The semiconductor may be silicon (Si), a group III-V semiconductor or some other binary semiconductor (e.g., GaAs), a tertiary semiconductor (e.g., AlGaAs), a higher order semiconductor, or the like. The semiconductor may be doped or undoped. The oxide layer 103 may be, for example, silicon dioxide (SiO₂) or the like. The oxide layer 103 may be operative as cladding for optical devices formed in the top layer 105. In some embodiments, the oxide layer 103 has a thickness in the range from about 0.5 m to about 4 m. The top layer 105 comprises an optical material such as silicon (Si), silicon nitride (Si₃N₄), lithium niobate (LiNbO₃), indium phosphide (InP), or the like. The top layer 105 has a higher refractive index than the oxide layer 103. In some embodiments, the top layer 105 is silicon. The silicon may be doped or undoped. In some embodiments, the top layer 105 has a thickness in the range from about 100 nm to about 1.5 m.

As shown by the cross-sectional view 3300 of FIG. 33, a mask 3301 may be formed and used to pattern the top layer 105 to form various optical structures including, for example, the waveguide 2903, the waveguide 111, and the like. The mask 3301 and other masks used in the present process may be a photoresist or a hard mask patterned using a photoresist or the like. A hard mask may be, for example, silicon nitride (Si₃N₄), silicon carbide (SiC), silicon oxynitride (SiON), aluminum nitride (AlN), the like, or any other suitable material. The mask 3301 and other masks used in the present process may be patterned by photolithography, electron beam lithography, the like, or any other suitable method.

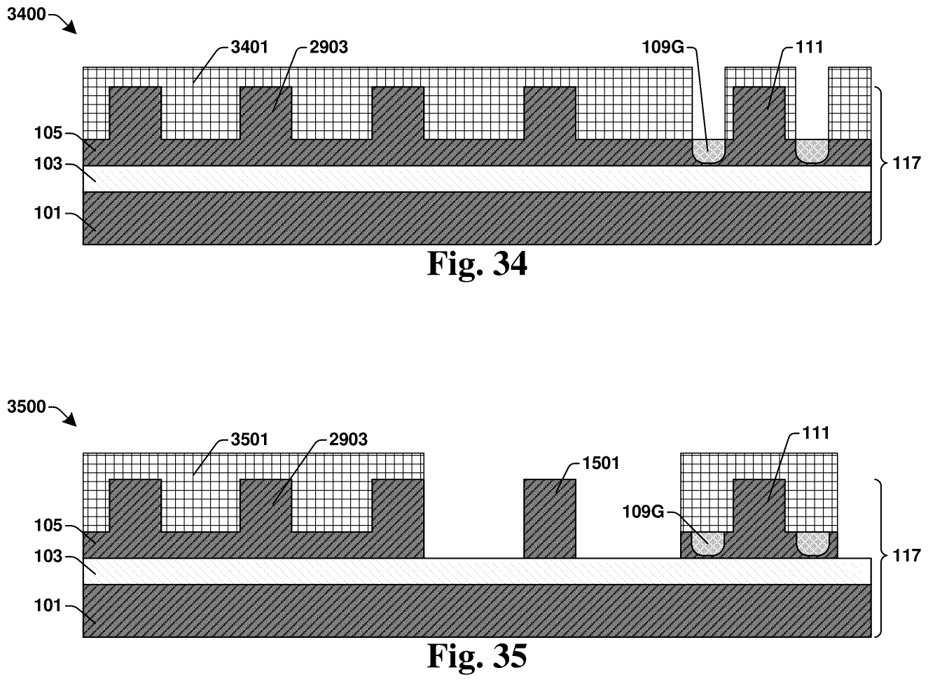

As shown by the cross-sectional view 3400 of FIG. 34, a mask 3401 may be patterned and used to define locations for stress structures 109G in the top layer 105. In some embodiments, the stress structures 109G are formed by etching and refilling the exposed areas of the top layer 105. In some embodiments, the top layer 105 is semiconductor, the refill process is an epitaxial growth process, and the stress structures 109G comprise a semiconductor. The semiconductor could be silicon (Si), silicon geranium (SiGe), the like, or any other semiconductor provided that the semiconductor can be formed at an elevated temperature and has a CTE mismatch with the top layer 105. In some embodiments, the refill process is a deposition process such as chemical vapor deposition (CVD), physical vapor deposition (PVD), atomic layer deposition (ALD), or the like. Examples of material that might be deposited include amorphous semiconductors such as polysilicon, dielectrics, metals, or a combination thereof. A dielectric could be a low-K dielectric, silicon dioxide (SiO₂), a high-x dielectric, or the like. In some embodiments, the refill process uses a sol-gel technique or the like. In some embodiments, the refill material is porous. In some embodiments, the top layer 105 is a dielectric optical material such as silicon nitride (Si₃N₄) the refill material has the same molecular composition as the dielectric optical material but with a difference atomic ratio, e.g., silicon nitride (SiₓN_{y}).

In some embodiments, the stress structures 109G are formed by treating the exposed portions of the top layer 105 so that the stress structures 109G comprise the composition of the top layer 105 with a suitable modification. In some embodiments, the treatment is ion implantation. In some embodiments, Si⁺⁺ ions or the like are implanted. The implantation process may be followed by annealing, e.g., about 4 hours at about 120° C. In some embodiments, the treatment process is laser annealing. Ion implantation or laser annealing can change the density and/or crystal structure of the optical material.

As shown by the cross-sectional view 3500 of FIG. 35, a mask 3501 may be formed and etching carried out to further pattern the top layer 105. This second stage of processing may extend more deeply into the top layer to form structures such as the waveguide 1501, which is of the ribbon type.

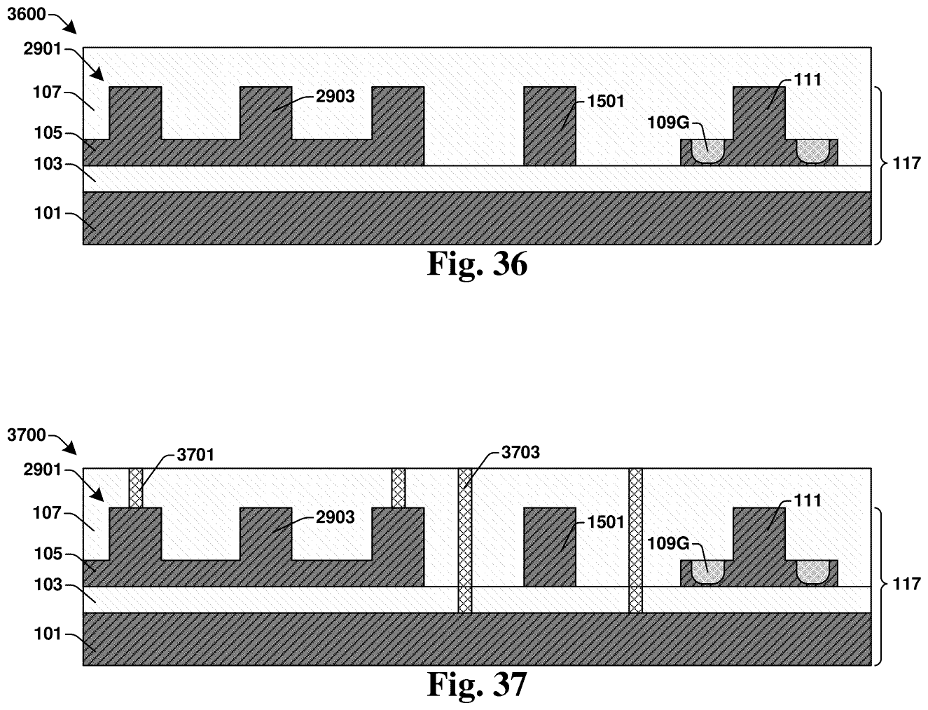

As shown by the cross-sectional view 3600 of FIG. 36, cladding 107 is deposited over the patterned top layer 105. In some embodiments, the cladding 107 is an oxide. In some embodiments, the cladding 107 has the same composition as the oxide layer 103. More generally, the cladding 107 may be silicon dioxide (SiO₂), silicon nitride (Si₃N₄), hafnium oxide (HfO₂), zirconium oxide (HfO₂), aluminum oxide (Al₂O₃), the like, or any other suitable cladding material. The cladding 107 may be deposited by chemical vapor deposition (CVD), physical vapor deposition (PVD), the like, or any other suitable process. A planarization process may be carried out after deposition of the cladding. A second cladding material (not shown) may be deposited to facilitate planarization. For example, borophosphosilicate glass (BPSG) or the like may be used to fill in low spots over silicon dioxide (SiO₂) cladding. The second cladding material is generally outside the optical propagation regions of the optical devices but may be a source of stress noise.

As shown by the cross-sectional view 3700 of FIG. 37, contact plugs 3701 may be formed in the cladding 107 to make electrical contacts with optical devices. The contact plugs 3701 may be formed by etching holes and filling them with conductive material. The conductive material may be metal or some other suitable type of material. The metal may be copper (Cu), silver (Si), gold (Au), tungsten (W), cobalt (Co), aluminum (Al), the like, alloys thereof, or any other suitable metal. The conductive material may be deposited by CVD, PVD, electroplating, electroless plating, the like, or any other suitable process. Deeper contact plugs 3703 may be formed for contacting the handle substrate 101 or for providing electrical connection to structures that will subsequently be formed on the back side of the BOX substrate 117. Dummy versions of the contact plugs 3703 may be used to provide stress structures.

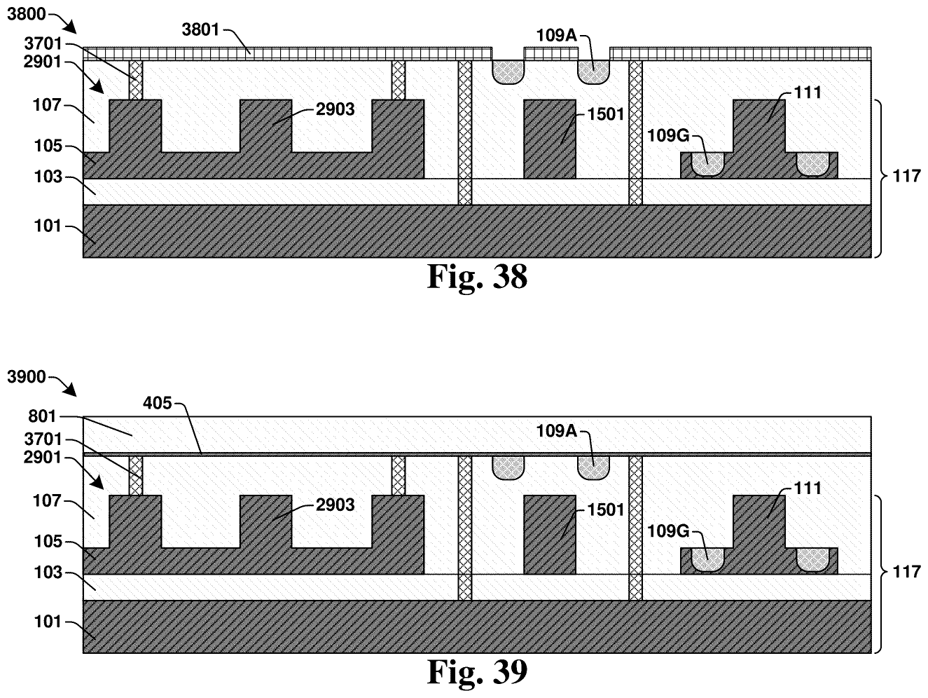

As shown by the cross-sectional view 3800 of FIG. 38, a mask 3801 may be patterned and used to form stress structures 109A or the like in the cladding 107 at select locations. In some embodiments, the stress structures 109A are formed by etching and refilling the exposed areas of the cladding 107. In some embodiments, the refill material has a same composition as the cladding 107 but is deposited under different conditions so that the stress structures 109A have a different CTE from the cladding 107. In some embodiments, the refill material has the same atomic composition as the cladding 107, but the refill material has a different atomic ratio that contributes to providing the difference in CTE. For example, both the cladding 107 and the stress structures 109A may be SiₓN_{y}, AlₓOy, ZrₓHf_{y}O_{z}, or the like. The refill process may be a deposition process such as chemical vapor deposition (CVD), physical vapor deposition (PVD), atomic layer deposition (ALD), or the like. In some embodiments, the refill process uses a sol-gel technique or the like. In some embodiments, the refill material is porous.

In some embodiments, the stress structures 109A are formed by treating the exposed portions of the cladding 107 so that the stress structures 109A comprise the composition of the cladding 107 with a suitable modification. In some embodiments, the treatment process is ion implantation. Examples of ions that may be suitable for implantation in the cladding 107 so at to change the CTE of the implanted area include ions of xenon (Xe), argon (Ar), nitrogen (N), and the like. The implantation process may be followed by annealing, e.g., about 4 hours at 1000° C. In some embodiments, the treatment process is laser annealing.

As shown by the cross-sectional view 3900 of FIG. 39, an etch stop layer 405 and the interlevel dielectric 801 may be formed over the cladding 107. The etch stop layer 405 may be, for example, silicon nitride (Si₃N₄), silicon carbide (SiC), silicon oxynitride (SiON), aluminum nitride (AlN), the like, or any other suitable material. The interlevel dielectric 801 may be silicon dioxide (SiO₂), a low k dielectric, the like, or any other suitable material. The interlevel dielectric 801 may be deposited by CVD, PVD, the like, or any other suitable process.

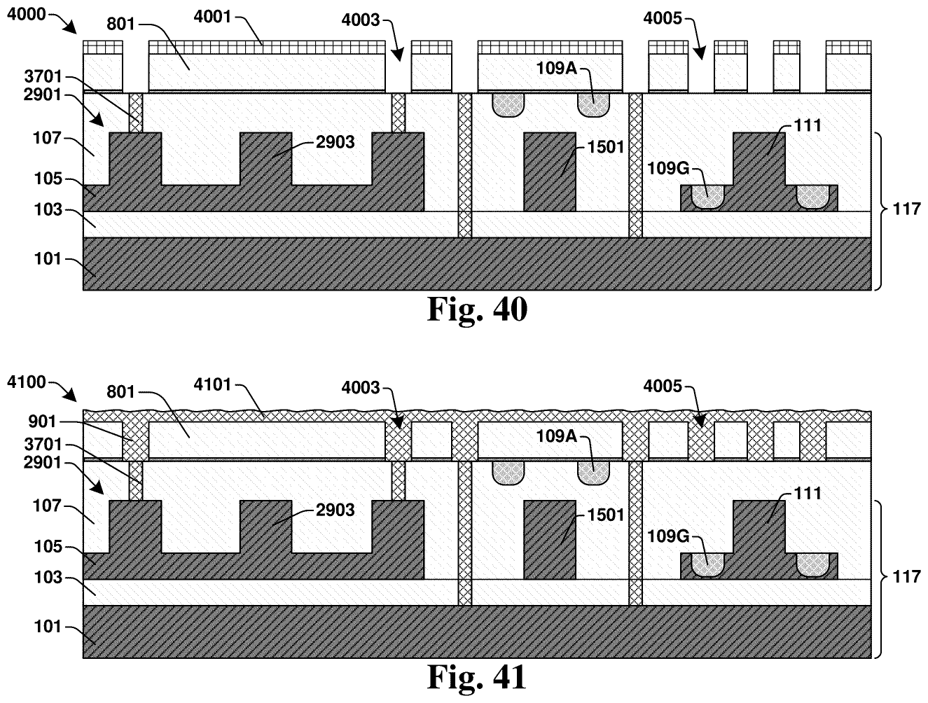

As shown by the cross-sectional view 4000 of FIG. 40, a mask 4001 may be formed and used to etch trenches 4003 and holes 4005 through the interlevel dielectric 801. As shown by the cross-sectional view 4100 of FIG. 41, the mask 4001 may be stripped and a metal 4101 may be deposited so as to fill the trenches 4003 and the holes 4005. The metal 4101 may be copper (Cu), silver (Si), gold (Au), tungsten (W), cobalt (Co), aluminum (Al), the like, alloys thereof, or any other suitable metal. The metal 4101 may be deposited by CVD, PVD, electroplating, electroless plating, the like, or any other suitable process.

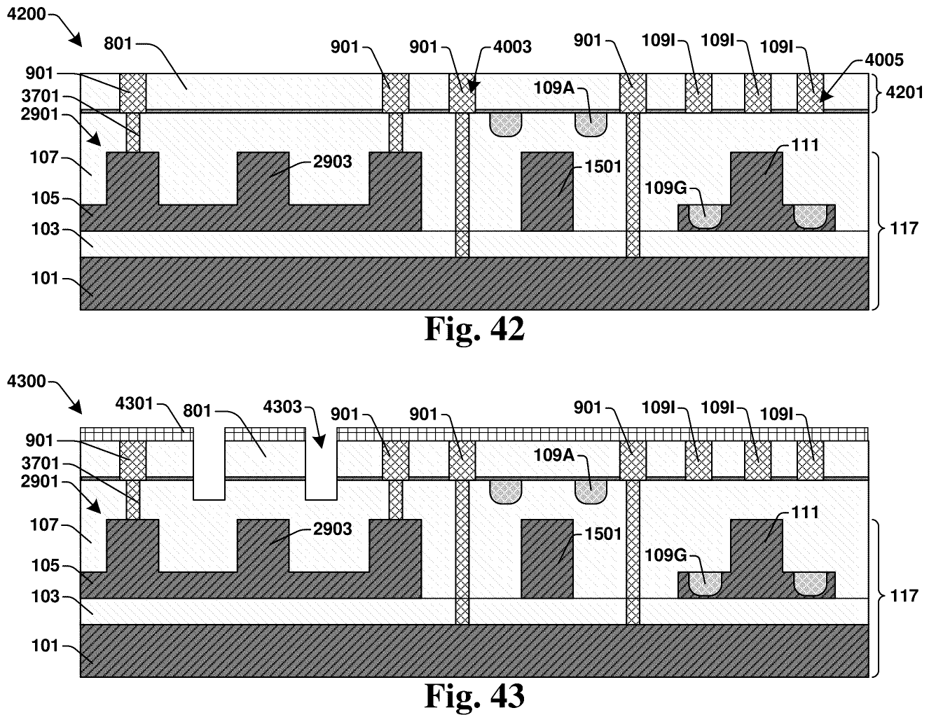

As shown by the cross-sectional view 4200 of FIG. 42, a planarization process may be carried out to remove the metal 4101 that deposited outside the trenches 4003 and the holes 4005. The metal 4101 that remains in the trenches 4003 provides wires 901. The metal 4101 that remains in the trenches 4003 provides stress structures 1091. The wires 901 and the interlevel dielectric 801 provide a first metallization layer 4201. The stress structures 1091 are dummy metal structures within the first metallization layer 4201. The first metallization layer 4201 may contain other dummy metal structures (not shown). These other dummy metal structures may not enhance any optical devices.

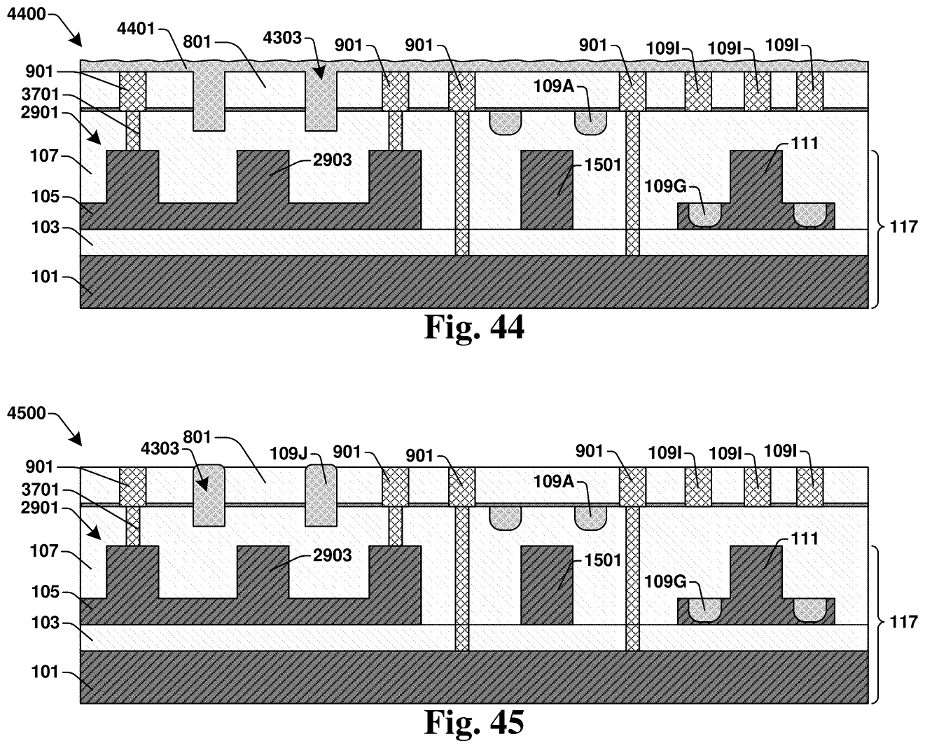

As shown by the cross-sectional view 4300 of FIG. 43, a mask 4301 may be formed and used to etch holes 4303 through the interlevel dielectric 801. In some embodiments, the holes 4303 continue into the cladding 107. As shown by the cross-sectional view 4400 of FIG. 44, the mask 4301 may be stripped and a material 4401 may be deposited so as to fill the holes 4303. The material 4401 may be a dielectric, a semiconductor, or a metal. In some embodiments, the material 4401 is a dielectric. In some embodiments, the material 4401 shares a composition with the interlevel dielectric 801. In some embodiments, the material 4401 shares a composition with the cladding 107. The material 4401 may be deposited by CVD, PVD, electroplating, electroless plating, the like, or any other suitable process. In some embodiments, the material 4401 is porous. In some embodiments, the material 4401 is deposited using a sol-gel technique or the like.

As shown by the cross-sectional view 4500 of FIG. 45, a planarization process may be carried out to remove the material 4401 that deposits outside the holes 4303. A remaining portion of the material 4401 provides the stress structures 109J or other stress structures embedded in the interlevel dielectric 801 or the cladding 107. The planarization process may be chemical mechanical polishing (CMP), the like, or any other suitable process. The planarization process may leave the stress structures 109J with rounded tops.

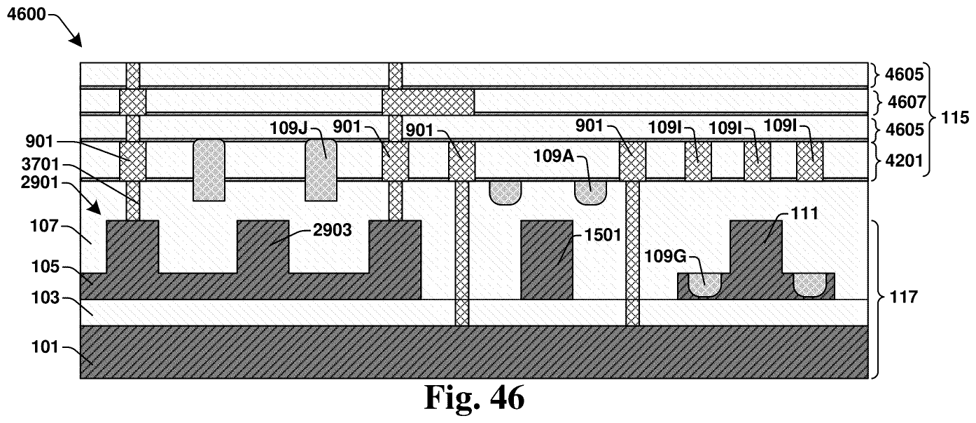

As shown by the cross-sectional view 4600 of FIG. 46, via layers 4605 and additional metallization layers 4607 may be formed to complete the metal interconnect structure 115. There may be a greater or lesser number of metallization layers 4607 than are illustrated. The via layers 4605 and the additional metallization layers 4607 may be formed by damascene processes, dual damascene processes, the like, or any other suitable method.

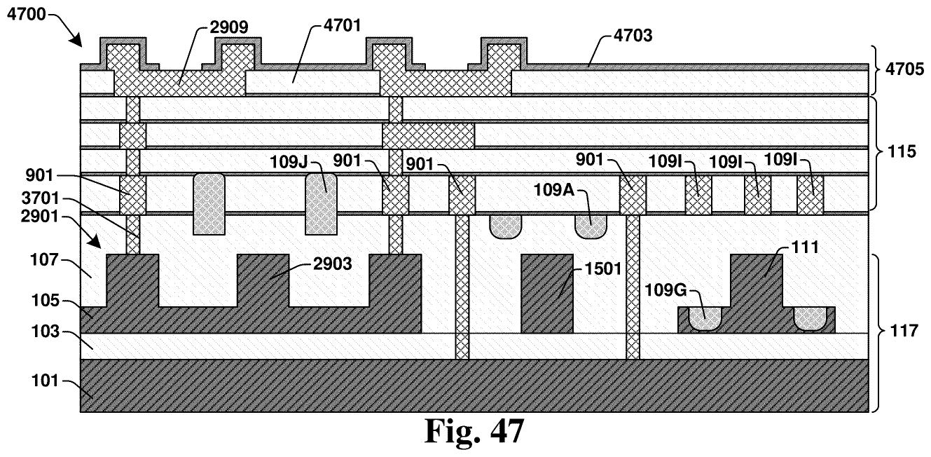

As shown by the cross-sectional view 4700 of FIG. 47, a bonding layer 4705 may be formed over the metal interconnect structure 115. The bonding layer 4705 may include a passivation layer 4701, a passivation layer 4703, contact pads 2909, the like, or other suitable insulating, protecting, and bonding structures.

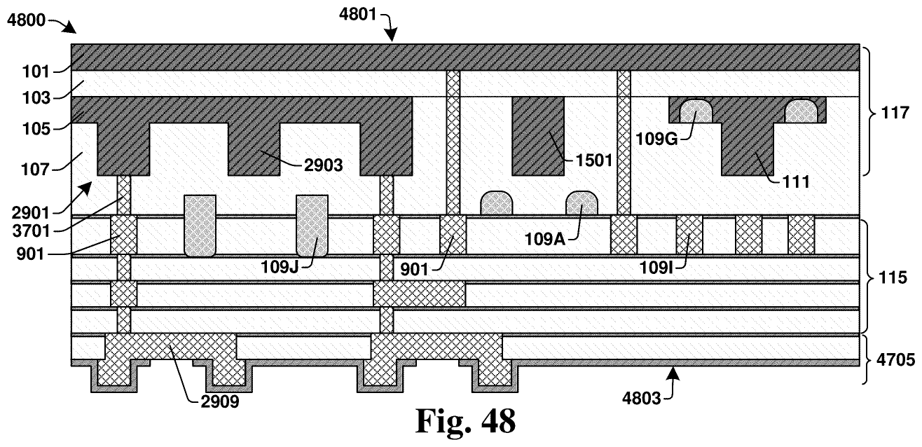

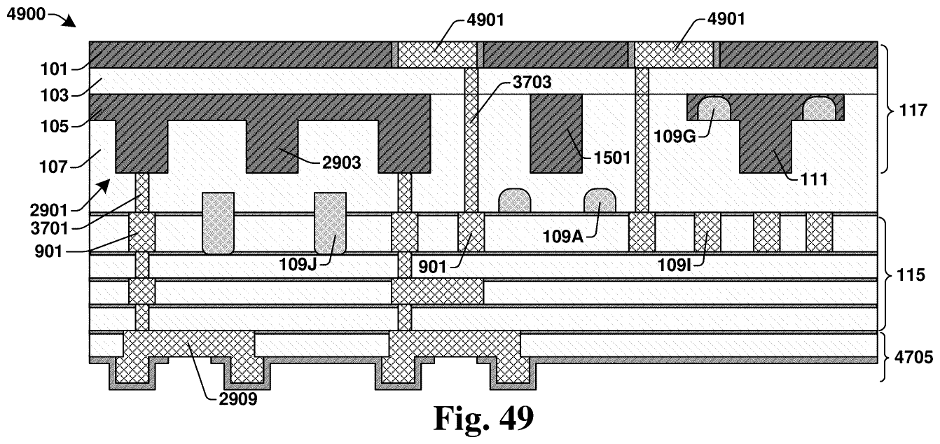

As shown by the cross-sectional view 4800 of FIG. 48, the BOX substrate 117 may be inverted and thinned from the back side 4801. The thinning process may remove all or part of the handle substrate 101. Optionally, the front side 4803 of the BOX substrate 117 is attached to a carrier substrate (not shown) prior to thinning.

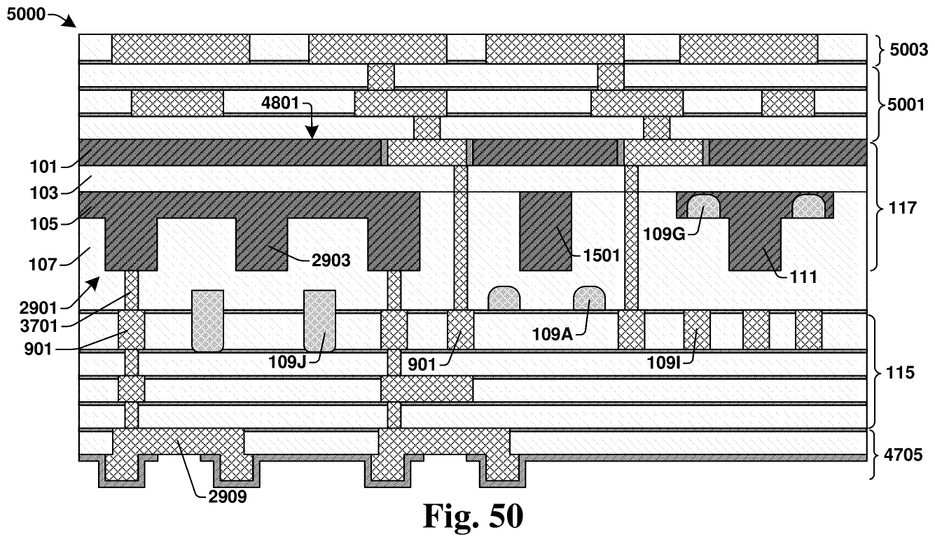

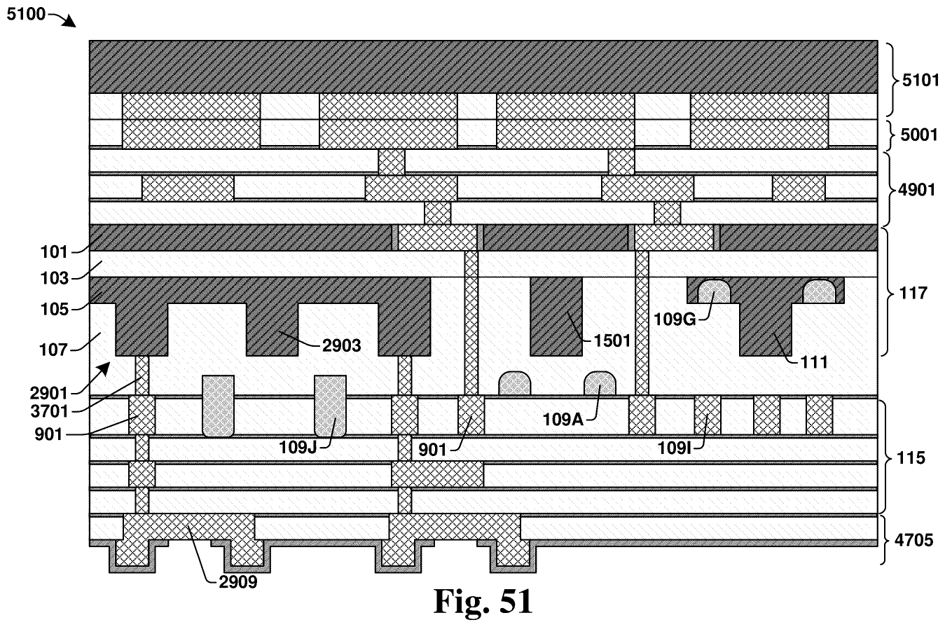

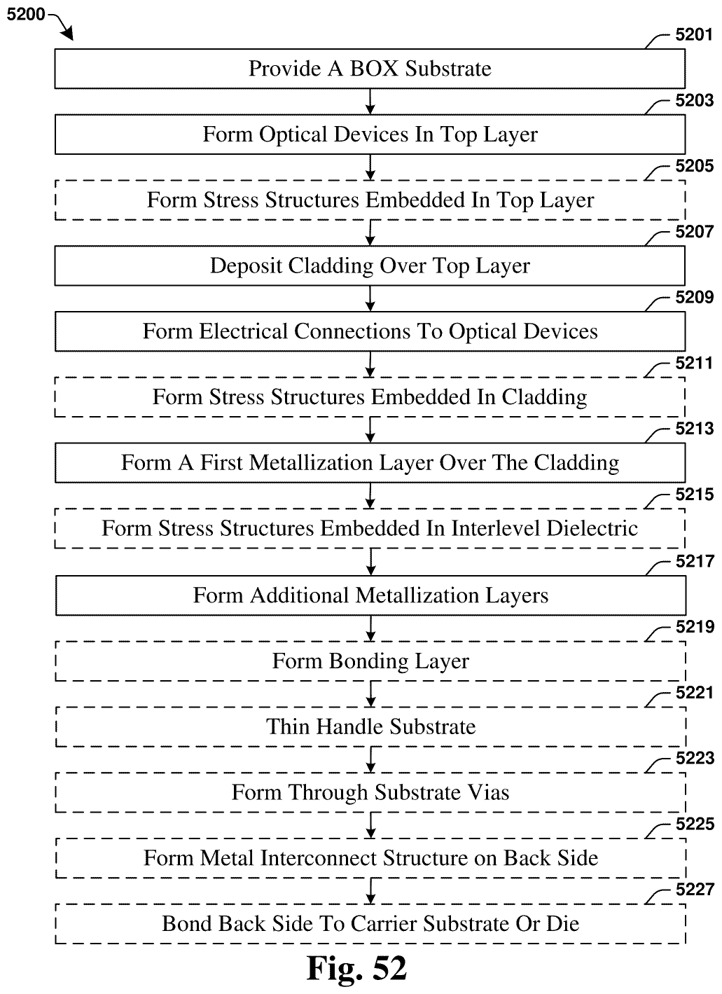

As shown by the cross-sectional view 4900 of FIG. 49, through substrate vias 4901 may be formed through the handle substrate 101 so as to couple with the deeper contact plugs 3703 and so to the metal interconnect structure 115. As shown by the cross-sectional view 5000 of FIG. 50, a metal interconnect structure 5001 and a bonding layer 5003 may be formed on the back side 4801. As shown by the cross-sectional view 5100 of FIG. 51, the BOX substrate 117 may then be bonded to a second substrate 5101. The second substrate 5101 may be a carrier substrate or another photonic or electrical integrated circuit device.

FIG. 52 presents a flow chart for a manufacturing process 5200 that may be used to form a PIC device according to the present disclosure. While the process 5200 of FIG. 52 is illustrated and described herein as a series of acts or events, it will be appreciated that the illustrated ordering of such acts or events is not to be interpreted in a limiting sense. For example, some acts may occur in different orders and/or concurrently with other acts or events apart from those illustrated and/or described herein. Further, not all illustrated acts are required to implement one or more aspects or embodiments of the description herein, and one or more of the acts depicted herein may be carried out in one or more separate acts and/or phases.

The manufacturing process 5200 may begin with act 5201, providing a BOX substrate. A box substrate includes a handle substrate, an oxide layer, and a top layer. The top layer has a thickness and is of a material suitable for waveguides and other optical devices. The cross-sectional view 3200 of FIG. 32 illustrates an example of this type of substrate. Alternatively, another type of substrate could be used.

The manufacturing process 5200 may continue with act 5203, forming optical devices in the top layer. Forming optical devices in the top layer may include forming masks, dry etching, wet etching, depositions, ion implantations, the like, or other suitable processing. Examples of optical devices that may be formed include waveguides, splitters, multiplexers, filters, modulators (e.g., a phase shifter, a PiN modulator, or an electro-absorption modulator), sensors, switches (e.g., a Mach-Zehnder interferometer), amplifiers, edge couplers, grating couplers, ring resonators, laser diodes, light-emitting diodes, photodetectors, or the like. The cross-sectional views 3300 of FIG. 33 and 3500 of FIG. 35 provide examples of this processing.

Act 5205 is an optional step of forming stress structures embedded in the top layer. The cross-sectional view 3400 of FIG. 34 provides an example. In some embodiments, these stress structures are formed by etching and filling holes in the top layer. In some embodiments, stress structures are formed by localized treatments of the top layer.

Act 5207 is depositing cladding over the top layer. The cross-sectional view 3600 of FIG. 36 provides an example. Act 5209 is forming contact plugs in the cladding for making electrical connection to the optical devices. The cross-sectional view 3700 of FIG. 37 provides an example.

Act 5211 is an optional step of forming stress structures embedded in the cladding. The cross-sectional view 3800 of FIG. 38 provides an example. In some embodiments, these stress structures are formed by etching and filling holes in the cladding. In some embodiments, stress structures are formed by localized treatments of the cladding.

Act 5213 is forming a first metallization layer over the cladding. The cross-sectional views 3900-4200 of FIGS. 39-42 provide an example. In some embodiments, dummy metal structures in the first metallization layer are positioned and shaped to provide stress structures. Dummy metal in other metallization layers above the first metallization layer may also be used to provide or contribute to stress structures.

The first metallization layer includes an interlevel dielectric. Act 5215 is an optional step of forming stress structures embedded in the interlevel dielectric. The cross-sectional views 4300-4500 of FIGS. 43-45 provide an example. In some embodiments, these stress structures are formed by etching and filling holes in the interlevel dielectric. Such stress structures may extend into the cladding. In some embodiments, stress structures are formed in the interlevel dielectric by localized treatments of the interlevel dielectric. Stress structures may also be formed in interlevel dielectric above the first metallization layer.

Act 5217 is an optional step of forming additional metallization and via layers to complete the formation of a metal interconnect structure. The cross-sectional view 4600 of FIG. 46 provides an example. Act 5219 is an optional step of forming a bonding layer over the metal interconnect structure. The cross-sectional view 4700 of FIG. 47 provides an example. Act 5221 is an optional step of polishing or grinding to thin or remove the handle substrate. The cross-sectional view 4800 of FIG. 48 provides an example. Act 5223 is an optional step of forming through substrate vias. The cross-sectional view 4900 of FIG. 49 provides an example. Through substrate vias may optionally be used to provide stress structures.

Act 5225 is an optional step of forming a metal interconnect structure on the back side. The cross-sectional view 5000 of FIG. 50 provides an example. Act 5227 is an optional step of bonding to a carrier substrate or to another integrated circuit device via the back side. The cross-sectional view 5100 of FIG. 51 provides an example.

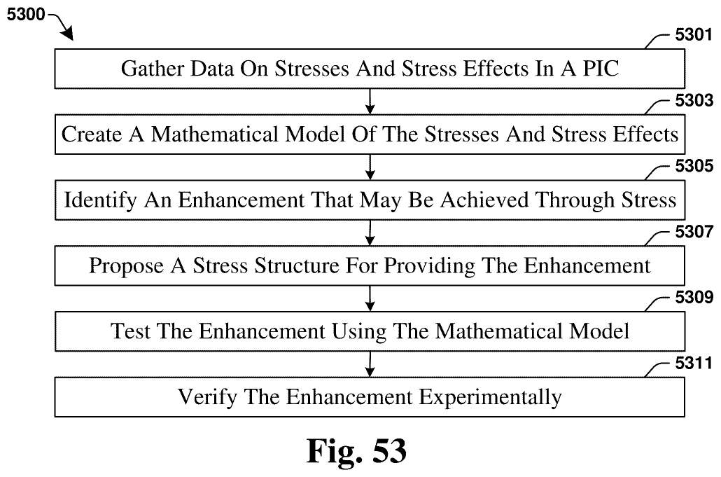

FIG. 53 presents a flow chart for a design process 5300 that may be used to design a PIC device according to the present disclosure. While the process 5300 of FIG. 53 is illustrated and described herein as a series of acts or events, it will be appreciated that the illustrated ordering of such acts or events is not to be interpreted in a limiting sense. For example, some acts may occur in different orders and/or concurrently with other acts or events apart from those illustrated and/or described herein. Further, not all illustrated acts are required to implement one or more aspects or embodiments of the description herein, and one or more of the acts depicted herein may be carried out in one or more separate acts and/or phases.

The design process 5300 may begin with act 5301, gathering data on stress effects in a PIC. The focus may be on a particular optical device in the PIC or a group of devices. The data may include measurements of strain in a current design by techniques such as x-ray diffraction, Raman spectroscopy, or the like. Additional data may include CTEs, manufacturing temperatures, relationships between stress and strain, and relationships between stress and refractive index.

Act 5303 is creating a mathematical model and conducting computer simulations to represent the measured stresses. The model may be three-dimensional, although two-dimensional modeling may be sufficient. The model is tuned until it gives a reasonable match to the data.

Act 5305 is identifying an enhancement to an optical device that can be achieved through a stress structure. In some embodiments, this means identifying an optical device that is being adversely affected by unplanned stresses. In some embodiments, this means identifying an optical device that can be tuned using stress.

Act 5307 is proposing a stress structure for providing the enhancement. The present disclosure provides many options for location, shape, and composition of stress structures. Act 5309 is putting the proposed structure into the model to determine if it provides the desired enhancement. In some embodiments, act 5309 includes determining whether the proposed stress structure counteracts the unplanned stresses. In some embodiments, act 5309 includes determining whether the proposed stress structure provides the sought after tuning. If the proposed stress structure does not provide the desired enhancement, the proposed stress structure is modified, and the simulation repeated until a satisfactory result is achieved.

Act 5311 is experimentally determining whether the proposed stress structure provides the desired enhancement. If the desired enhancement is not realized, the model may be updated to match the data and act 5309 through 5311 repeated until the desired result is achieved.

Some aspects of the present disclosure relate to a photonic integrated circuit device that include a BOX substrate, cladding over the BOX substrate, and a metal interconnect structure over the cladding. A PIC include an optical device for which a top layer of the BOX substrate and the cladding provide an optical propagation region. A stress structure is shaped and positioned so as to affect a stress field in the optical propagation region and to thereby enhance the optical device. In some embodiments, the stress structure is provided as a plurality of islands of material, each island having intrinsic stress. In some embodiments, the intrinsic stress is a result of a CTE mismatch with surrounding material. In some embodiments, the intrinsic stress is a result of ion implantation. In some embodiments, the islands form two or more rows in a symmetric arrangement around the optical device. In some embodiments, the optical device defines an optical transmission path, and the islands form a row that parallels the optical transmission path.

In some embodiments, the stress structure is embedded within the cladding. In some embodiments, the stress structure is embedded in a top layer of the BOX substrate. In some embodiments, the stress structure is embedded within the metal interconnect structure. In some embodiments, the stress structure is provided by dummy metal within the metal interconnect structure. In some embodiments, the stress structure includes a composition of an adjacent material and has a different density from the adjacent material. In some embodiments, the stress structure has the same composition as an adjacent material except for a difference in atomic ratio.

In some embodiments, the optical device is a mode converted and the stress structure causes a transition from TM mode preferred to TE mode preferred along the length of a waveguide of the mode converter. In some embodiments, the optical device is a photodetector, and the stress structure alters an absorption spectrum of the photodetector. In some embodiments, the optical device is a waveguide, and the stress structure affects whether the waveguide is TM mode preferred or TE mode preferred. In some embodiments, the optical device is a PiN modulator comprising a waveguide, and the stress structure affects whether the waveguide is TM mode preferred or TE mode preferred at a particular voltage. In some embodiments, the optical device is a ring resonator, and the stress structure affects a coupling wavelength for the ring resonator. In some embodiments, the optical device is an electro-absorption modulator, and the stress structure alters a relationship between applied voltage and absorption spectrum for the electro-absorption modulator.

Some aspects of the present disclosure relate to a device that includes a PIC. The PIC includes an optical device within an optical propagation region. The optical propagation region includes an optical material and cladding. The optical device defines an optical transmission pathway through the optical propagation region. A stress structure exerts stress on the optical propagation region. The stress varies periodically along the optical transmission pathway.

Some aspects of the present disclosure relate to a method that includes providing a BOX substrate having a handle substrate, a buried oxide layer, and a top layer. A PIC including an optical device is formed by processing that includes etching the top layer and depositing cladding over the top layer after etching. A stress structure is formed at a first temperature. After cooling, the stress structure applies stress to the optical device. In some embodiments, forming the stress structure includes ion implantation. In some embodiments, forming the stress structure includes laser annealing. In some embodiments, forming the stress structure includes porous material deposition. In some embodiments, forming the stress structure includes etching a hole, filling the hole, and chemical mechanical polishing, wherein the chemical mechanical polishing rounds an upper surface of the stress structure. In some embodiments, a metal interconnect structure including a metallization layer is formed over the cladding and the metal interconnect structure comprises dummy metal that provides the stress structure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A photonic integrated circuit device, comprising:
a buried oxide substrate comprising a substrate, a top layer, and a buried oxide layer between the substrate and the top layer;
cladding over the top layer;
a metal interconnect structure disposed over the cladding;
a photonic integrated circuit comprising an optical device within an optical propagation region, wherein the optical propagation region comprises the top layer and the cladding; and
a stress structure comprising a plurality of islands of material having intrinsic stress, wherein the stress structure affects a stress field in the optical propagation region so as to enhance the optical device.

2. The photonic integrated circuit device of claim 1, wherein the stress structure is embedded within the cladding.

3. The photonic integrated circuit device of claim 1, wherein the stress structure comprises a composition of an adjacent material and has a different density from the adjacent material.

4. The photonic integrated circuit device of claim 1, wherein the stress structure is embedded in the top layer.

5. The photonic integrated circuit device of claim 1, wherein the stress structure is provided by dummy metal within the metal interconnect structure.

6. The photonic integrated circuit device of claim 1, wherein the optical device is a mode converted comprising a waveguide, and the stress structure causes a transition from TM mode preferred to TE mode preferred along a length of the waveguide.

7. The photonic integrated circuit device of claim 1, wherein the optical device is a photodetector, and the stress structure alters an absorption spectrum of the photodetector.

8. The photonic integrated circuit device of claim 1, wherein the optical device is a waveguide, and the stress structure affects whether the waveguide is TM mode preferred or TE mode preferred.

9. The photonic integrated circuit device of claim 1, wherein the optical device is a PiN modulator comprising a waveguide, and the stress structure affects whether the waveguide is TM mode preferred or TE mode preferred at a particular voltage.

10. The photonic integrated circuit device of claim 1, wherein the optical device is a ring resonator, and the stress structure affects a coupling wavelength for the ring resonator.

11. The photonic integrated circuit device of claim 1, wherein the optical device is an electro-absorption modulator, and the stress structure alters a relationship between applied voltage and absorption spectrum for the electro-absorption modulator.

12. The photonic integrated circuit device of claim 1, wherein the islands form two or more rows in a symmetric arrangement around the optical device.

13. The photonic integrated circuit device of claim 1, wherein the optical device comprises an optical transmission path, and the islands form a row that parallels the optical transmission path.

14. A device, comprising:
a photonic integrated circuit comprising an optical device within an optical propagation region, wherein the optical propagation region comprises an optical material and cladding, and the optical device comprises an optical transmission pathway through the optical propagation region; and
a stress structure that exerts stress on the optical propagation region that varies periodically along the optical transmission pathway.

15. A method, comprising:
providing a buried oxide substrate comprising a substrate, a buried oxide layer, and a top layer;
forming a photonic integrated circuit by processing that includes etching the top layer and depositing cladding over the top layer after etching, wherein the photonic integrated circuit comprises an optical device; and
forming a stress structure at a first temperature, wherein the stress structure applies stress to the optical device after cooling.

16. The method of claim 15, wherein forming the stress structure comprises ion implantation.

17. The method of claim 15, wherein forming the stress structure comprises laser annealing.

18. The method of claim 15, wherein forming the stress structure comprises porous material deposition.

19. The method of claim 15, wherein forming the stress structure comprises etching a hole, filling the hole, and chemical mechanical polishing, wherein the chemical mechanical polishing rounds an upper surface of the stress structure.

20. The method of claim 15, further comprising forming a metal interconnect structure comprising a metallization layer over the cladding, wherein the metal interconnect structure comprises dummy metal that provides the stress structure.
